(19) United States
(12) Patent Application Publication
(10) Pub. No.: US 2025/0070844 A1
(43) Pub. Date: Feb. 27, 2025

(54) ROTATED ANTENNA ARRAYS FOR WIRELESS COMMUNICATIONS

(71) Applicant: QUALCOMM INCORPORATED, San Diego, CA (US)

(72) Inventors: Juergen Cezanne, Ocean Township, NJ (US); Meilong Jiang, Westfield, NJ (US); Danlu Zhang, San Diego, CA (US); Yu Zhang, San Diego, CA (US); Junyi Li, Greentown, PA (US); Ashwin Sampath, Skillman, NJ (US); Qiang Wu, San Diego, CA (US); Ozge Koymen, Princeton, NJ (US); Ori Shental, Marlboro, NJ (US)

(21) Appl. No.: 18/721,124

(22) PCT Filed: Feb. 25, 2022
(86) PCT No.: PCT/CN2022/077907

§ 371 Date: Jun. 17, 2024

(51) Int. Cl. H04B 7/06; H01Q 21/20

(52) U.S. Cl. CPC H04B 7/0691; H01Q 21/20; H04B 7/0617

(57) ABSTRACT

Methods, systems, and devices for wireless communications are described. A transmitting device may include a first set of antenna arrays disposed in a first shape and a receiving device may include a second set of antenna arrays disposed in a second shape. A first axis that intersects an antenna array of the first set of antenna arrays and a centroid of the first shape may be offset from a vertical direction by a first angular offset. A second axis that intersects an antenna array of the second set of antenna arrays and a centroid of the second shape may be offset from the vertical direction by a second angular offset that is different than the first angular offset. The transmitting device may transmit signaling to the receiving device using the first and second sets of antenna arrays, respectively based on difference between the first and second angular offsets.

### CROSS REFERENCE

The present application is a 371 national stage filing of International PCT Application No. PCT/CN2022/077907 by Cezanne et al. entitled “ROTATED ANTENNA ARRAYS FOR WIRELESS COMMUNICATIONS,” filed Feb. 25, 2022, which is assigned to the assignee hereof, and which is expressly incorporated by reference in its entirety herein.

### FIELD OF TECHNOLOGY

The following relates to wireless communications, including rotated antenna arrays for wireless communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communications systems, wireless devices, such as base stations, UEs, network devices, or any combination thereof, may communicate directionally, for example, using beams to orient communication signals over one or more directions. In some systems, the wireless devices may generate multiple beams using one or more antenna subarrays disposed in a shape, such as a circle, a square, or a spiral, at each respective device. Such antenna configurations may, in addition to providing signal directionality, provide additional dimensions for signal multiplexing. Antenna subarrays at a transmitting device may be disposed in a same shape, may be aligned with antenna subarrays at a receiving device, or both.

### SUMMARY

The described techniques relate to improved methods, systems, devices, and apparatuses that support rotated antenna arrays for wireless communications. Generally, the described techniques provide for each antenna subarray of a first antenna array including a first set of antenna subarrays at a transmitting device to be offset from each antenna subarray of a second antenna array including a second set of antenna subarrays at a second device to improve communication reliability. The transmitting device may include the first set of antenna subarrays disposed along a perimeter of a first shape, and the receiving device may include the second set of antenna subarrays disposed along a perimeter of a second shape. Each antenna subarray of the first and second sets of antenna subarrays may include one or more antenna elements. The first and second shapes may be closed shapes (e.g., circles, quadrilaterals, or triangles) or open shapes (e.g., spirals). A first axis that extends between a pair of antenna elements of the first set of antenna subarrays and a centroid of the first shape may be offset from a vertical direction by a first angular offset. A second axis that extends between a pair of antenna elements of the second set of antenna subarrays and a centroid of the second shape may be offset from the vertical axis by a second angular offset that is different than the first angular offset. The second axis may be at least as nearly parallel to the first axis as any other axis that extends between at least two antenna elements of the second set of antenna subarrays and intersects the centroid of the second shape (e.g., the second axis may have a difference in angular offset relative to the first axis that is at least as small as the difference for any other axis that extends between at least two antenna elements of the second set of antenna subarrays and intersects the centroid: no other axis that extends between at least two antenna elements of the second set of antenna subarrays and intersects the centroid may be any smaller than the difference in angular offset between the second axis and the first axis).

A difference between the first angular offset and the second angular offset may correspond to an angular offset between antenna subarrays to improve throughput and communication reliability. The transmitting device may transmit signaling to the receiving device using the first set of antenna subarrays. The receiving device may receive and decode the signaling using the second set of antenna subarrays. In some examples, the receiving device may transmit an indication of the second angular offset to the transmitting device, and the transmitting device may transmit the signaling based on a difference between the first angular offset and the second angular offset.

A method for wireless communication at a first device is described. The method may include transmitting signaling from a first antenna array including a first set of antenna subarrays at the first device to a second antenna array including a second set of antenna subarrays at a second device, where each antenna subarray of the first set of antenna subarrays and each antenna subarray of the second set of antenna subarrays may include one or more antenna elements. In some examples, a first axis that intersects an antenna subarray of the first set of antenna subarrays and a centroid of a first shape may be offset from a vertical direction by a first angular offset and each antenna subarray of the first set of antenna subarrays may be disposed along a perimeter of the first shape. In some examples, for each antenna subarray of the second set of antenna subarrays, a respective angular offset between a respective axis that intersects the antenna subarray of the second set of antenna subarrays and a centroid of a second shape is offset from the vertical direction by a respective angular offset different than the first angular offset, and each antenna subarray of the second set of antenna subarrays may be disposed along a perimeter of the second shape.

An apparatus for wireless communication at a first device is described. The apparatus may include a memory: a first antenna array including a first set of antenna subarrays; and at least one processor, the at least one processor coupled with the memory and the first set of antenna subarrays, and the at least one processor configured to cause the apparatus to transmit signaling from the first set of antenna subarrays at the first device to a second antenna array including a second set of antenna subarrays at a second device, where each antenna subarray of the first set of antenna subarrays and each antenna subarray of the second set of antenna subarrays may include one or more antenna elements. In some examples, a first axis that intersects an antenna subarray of the first set of antenna subarrays and a centroid of a first shape may be offset from a vertical direction by a first angular offset and each antenna subarray of the first set of antenna subarray's may be disposed along a perimeter of the first shape. In some examples, for each antenna subarray of the second set of antenna subarrays, a respective angular offset between a respective axis that intersects the antenna subarray of the second set of antenna subarrays and a centroid of a second shape is offset from the vertical direction by a respective angular offset different than the first angular offset, and each antenna subarray of the second set of antenna subarrays may be disposed along a perimeter of the second shape.

Another apparatus for wireless communication at a first device is described. The apparatus may include means for transmitting signaling from a first antenna array including a first set of antenna subarray's at the first device to a second antenna array including a second set of antenna subarrays at a second device, where each antenna subarray of the first set of antenna subarrays and each antenna subarray of the second set of antenna subarray's may include one or more antenna elements. In some examples, a first axis that intersects an antenna subarray of the first set of antenna subarrays and a centroid of a first shape may be offset from a vertical direction by a first angular offset and each antenna subarray of the first set of antenna subarrays may be disposed along a perimeter of the first shape. In some examples, for each antenna subarray of the second set of antenna subarrays, a respective angular offset between a respective axis that intersects the antenna subarray of the second set of antenna subarrays and a centroid of a second shape is offset from the vertical direction by a respective angular offset different than the first angular offset, and each antenna subarray of the second set of antenna subarray's may be disposed along a perimeter of the second shape.

A non-transitory computer-readable medium storing code for wireless communication at a first device is described. The code may include instructions executable by a processor to transmit signaling from a first antenna array including a first set of antenna subarrays at the first device to a second antenna array including a second set of antenna subarrays at a second device, where each antenna subarray of the first set of antenna subarray's and each antenna subarray of the second set of antenna subarrays may include one or more antenna elements. In some examples, a first axis that intersects an antenna subarray of the first set of antenna subarrays and a centroid of a first shape may be offset from a vertical direction by a first angular offset and each antenna subarray of the first set of antenna subarrays may be disposed along a perimeter of the first shape. In some examples, for each antenna subarray of the second set of antenna subarrays, a respective angular offset between a respective axis that intersects the antenna subarray of the second set of antenna subarrays and a centroid of a second shape is offset from the vertical direction by a respective angular offset different than the first angular offset, and each antenna subarray of the second set of antenna subarray's may be disposed along a perimeter of the second shape.

In some examples of the method, apparatuses, and non-transitory computer-readable medium described herein, within a set of angular offsets that includes the respective angular offset for each antenna subarray of the second set of antenna subarrays, each other angular offset may differ from the first angular offset by at least as much as a second angular offset, and a difference between the first angular offset and the second angular offset may be based on a first quantity of antenna subarrays within the first set of antenna subarrays at the first device, a second quantity of antenna subarrays within the second set of antenna subarrays at the second device, or both.

Some examples of the method, apparatuses, and non-transitory computer-readable medium described herein may further include operations, features, means, or instructions for receiving, from the second device, an indication of the second angular offset, where transmitting the signaling to the second device may be based on a difference between the first angular offset and the second angular offset.

In some examples of the method, apparatuses, and non-transitory computer-readable medium described herein, the first set of antenna subarrays at the first device and the second set of antenna subarrays at the second device both include a same quantity of antenna subarrays. In some examples of the method, apparatuses, and non-transitory computer-readable medium described herein, a first quantity antenna subarrays within the first set of antenna subarrays at the first device may be different than a second quantity of antenna subarrays within the second set of antenna subarrays at the second device.

In some examples of the method, apparatuses, and non-transitory computer-readable medium described herein, the first shape may be a first circle and the second shape may be a second circle. In some examples of the method, apparatuses, and non-transitory computer-readable medium described herein, each antenna subarray of the first set of antenna subarrays within the first antenna array may be located at a respective third angular offset relative to a third axis that bisects the first circle, and each antenna subarray of the second set of antenna subarrays within the second antenna array may be located at a respective fourth angular offset relative to a fourth axis that bisects the second circle. In some examples, the fourth axis may be parallel to the third axis and each respective third angular offset may be different than each respective fourth angular offset.

In some examples of the method, apparatuses, and non-transitory computer-readable medium described herein, the first shape may be a first quadrilateral and the second shape may be a second quadrilateral. In some examples of the method, apparatuses, and non-transitory computer-readable medium described herein, a third axis that may be parallel to two sides of the first quadrilateral and that intersects the centroid of the first quadrilateral may be parallel to the vertical direction or may be offset from the vertical direction by a third angular offset and a fourth axis that may be parallel to two sides of the second quadrilateral and intersects the centroid of the second quadrilateral may be offset from the vertical direction by a fourth angular offset that may be different than the third angular offset.

In some examples of the method, apparatuses, and non-transitory computer-readable medium described herein, a size of the first shape may be the same as a size of the second shape, the size including an area, a perimeter, a circumference, a diameter, or any combination thereof of the first shape and the second shape.

In some examples of the method, apparatuses, and non-transitory computer-readable medium described herein, a size of the first shape may be different than a size of the second shape, the size of the first shape including a first area, a first perimeter, a first circumference, a first diameter, or any combination thereof of the first shape, and the size of the second shape including a second area, a second perimeter, a second circumference, a second diameter, or any combination thereof of the second shape.

A method for wireless communication at a second device is described. The method may include receiving signaling from a first antenna array including a first set of antenna subarrays at a first device using a second antenna array including a second set of antenna subarray's at the second device, where each antenna subarray of the first set of antenna subarrays and each antenna subarray of the second set of antenna subarray's may include one or more antenna elements. In some examples, a first axis that intersects an antenna subarray of the first set of antenna subarrays and a centroid of a first shape may be offset from a vertical direction by a first angular offset, and each antenna subarray of the first set of antenna subarrays may be disposed along a perimeter of the first shape. In some examples, for each antenna subarray of the second set of antenna subarrays, a respective angular offset between a respective axis that intersects the antenna subarray of the second set of antenna subarrays and a centroid of a second shape is offset from the vertical direction by a respective angular offset different than the first angular offset, and each antenna subarray of the second set of antenna subarray's may be disposed along a perimeter of the second shape.

An apparatus for wireless communication at a second device is described. The apparatus may include a memory: a second antenna array including a second set of antenna subarrays; and at least one processor, the at least one processor coupled with the memory and the second set of antenna subarrays, and the at least one processor configured to cause the apparatus to receive signaling from a first antenna array including a first set of antenna subarrays at a first device using the second antenna array including the second set of antenna subarrays at the second device, where each antenna subarray of the first set of antenna subarrays and each antenna subarray of the second set of antenna subarrays may include one or more antenna elements. In some examples, a first axis that intersects an antenna subarray of the first set of antenna subarrays and a centroid of a first shape may be offset from a vertical direction by a first angular offset, and each antenna subarray of the first set of antenna subarrays may be disposed along a perimeter of the first shape. In some examples, for each antenna subarray of the second set of antenna subarrays, a respective angular offset between a respective axis that intersects the antenna subarray of the second set of antenna subarrays and a centroid of a second shape is offset from the vertical direction by a respective angular offset different than the first angular offset, and each antenna subarray of the second set of antenna subarray's may be disposed along a perimeter of the second shape.

Another apparatus for wireless communication at a second device is described. The apparatus may include means for receiving signaling from a first antenna array including a first set of antenna subarrays at a first device using a second antenna array including a second set of antenna subarrays at the second device, where each antenna subarray of the first set of antenna subarrays and each antenna subarray of the second set of antenna subarrays may include one or more antenna elements. In some examples, a first axis that intersects an antenna subarray of the first set of antenna subarray's and a centroid of a first shape may be offset from a vertical direction by a first angular offset, and each antenna subarray of the first set of antenna subarrays may be disposed along a perimeter of the first shape. In some examples, for each antenna subarray of the second set of antenna subarrays, a respective angular offset between a respective axis that intersects the antenna subarray of the second set of antenna subarrays and a centroid of a second shape is offset from the vertical direction by a respective angular offset different than the first angular offset, and each antenna subarray of the second set of antenna subarrays may be disposed along a perimeter of the second shape.

A non-transitory computer-readable medium storing code for wireless communication at a second device is described. The code may include instructions executable by a processor to receive signaling from a first antenna array including a first set of antenna subarrays at a first device using a second antenna array including a second set of antenna subarrays at the second device, where each antenna subarray of the first set of antenna subarrays and each antenna subarray of the second set of antenna subarrays may include one or more antenna elements. In some examples, a first axis that intersects an antenna subarray of the first set of antenna subarrays and a centroid of a first shape may be offset from a vertical direction by a first angular offset, and each antenna subarray of the first set of antenna subarrays may be disposed along a perimeter of the first shape. In some examples, for each antenna subarray of the second set of antenna subarrays, a respective angular offset between a respective axis that intersects the antenna subarray of the second set of antenna subarrays and a centroid of a second shape is offset from the vertical direction by a respective angular offset different than the first angular offset, and each antenna subarray of the second set of antenna subarray's may be disposed along a perimeter of the second shape.

In some examples of the method, apparatuses, and non-transitory computer-readable medium described herein, within a set of angular offsets that includes the respective angular offset for each antenna subarray of the second set of antenna subarrays, each other angular offset may differ from the first angular offset by at least as much as a second angular offset, and a difference between the first angular offset and the second angular offset may be based on a first quantity antenna subarrays within the first set of antenna subarrays at the first device, a second quantity of antenna subarrays within the second set of antenna subarrays at the second device, or both.

Some examples of the method, apparatuses, and non-transitory computer-readable medium described herein may further include operations, features, means, or instructions for transmitting, to the first device, a message indicating the second angular offset, where receiving the signaling from the first device may be based on a difference between the first angular offset and the second angular offset.

In some examples of the method, apparatuses, and non-transitory computer-readable medium described herein, a first quantity antenna subarrays within the first set of antenna subarrays at the first device may be the same as or different than a second quantity of antenna subarrays within the second set of antenna subarrays at the second device.

In some examples of the method, apparatuses, and non-transitory computer-readable medium described herein, the first shape and the second shape may be circular shapes or quadrilateral shapes.

An apparatus for wireless communication is described. The apparatus may include a first antenna array including a first set of antenna subarrays each including one or more antenna elements, where each antenna subarray of the first set of antenna subarrays may be disposed along a perimeter of a first shape. In some examples, a first axis that intersects an antenna subarray of the first set of antenna subarrays and a centroid of the first shape may be offset from a vertical direction by a first angular offset. The apparatus may include a processor and memory coupled with the processor. The memory and the processor may be configured to cause the apparatus to transmit signaling to or receive signaling from, a second antenna array at the second device using the first antenna array, where the second antenna array includes a second set of antenna subarrays and, for each antenna subarray of the second set of antenna subarrays, a respective angular offset between a respective axis that intersects the antenna subarray of the second set of antenna subarrays and a centroid of a second shape is offset from the vertical direction by a respective angular offset different than the first angular offset. In some examples, each antenna subarray of the second set of antenna subarrays may be disposed along a perimeter of the second shape.

In some examples of the apparatus described herein, within a set of angular offsets that comprises the respective angular offset for each antenna subarray of the second set of antenna subarrays, each other angular offset may differ from the first angular offset by at least as much as a second angular offset, and a difference between the first angular offset and the second angular offset may be based on a first quantity of antenna subarrays within the first set of antenna subarrays, a second quantity of antenna subarrays within the second set of antenna subarrays, or both.

In some examples of the apparatus described herein, the at least one processor may be further configured to cause the apparatus to receive, from the second device, an indication of the second angular offset and transmit the signaling to the second device based on a difference between the first angular offset and the second angular offset.

In some examples of the apparatus described herein, a first quantity of antenna subarrays within the first set of antenna subarrays may be the same as a second quantity of antenna subarrays within the second set of antenna subarrays. In some examples of the apparatus, a first quantity of antenna subarrays within the first set of antenna subarrays may be different than a second quantity of antenna subarrays within the second set of antenna subarrays.

In some examples of the apparatus described herein, the first shape may be a first circle and the second shape may be a second circle. In some examples of the apparatus, each antenna subarray of the first set of antenna subarrays within the first circle may be located at a respective third angular offset relative to a third axis that bisects the first circle, each antenna subarray of the second set of antenna subarrays within the second circle may be located at a respective fourth angular offset relative to a fourth axis that bisects the second circle, the fourth axis parallel to the third axis and the vertical direction, and each respective third angular offset may be different than each respective fourth angular offset.

In some examples of the apparatus described herein, the first shape may be a first quadrilateral and the second shape may be a second quadrilateral. In some examples of the apparatus, a third axis that is parallel to two sides of the first quadrilateral and that intersects the centroid of the first quadrilateral may be offset from the vertical direction by a third angular offset and a fourth axis that is parallel to two sides of the second quadrilateral and intersects the centroid of the second quadrilateral may be offset from the vertical direction by a fourth angular offset that is different than the third angular offset.

A system for wireless communication is described. The system may include a first device including a first antenna array that includes a first set of antenna subarrays that each include one or more antenna elements, where each antenna subarray of the first set of antenna subarrays may be disposed along a perimeter of a first shape, and a second device including a second antenna array that includes a second set of antenna subarrays that each include one or more antenna elements, where each antenna subarray of the second set of antenna subarrays may be disposed along a perimeter of a second shape. In some examples, a first axis that intersects an antenna subarray of the first set of antenna subarrays and a centroid of the first shape may be offset from a vertical direction by a first angular offset, and for each antenna subarray of the second set of antenna subarrays, a respective angular offset between a respective axis that intersects the antenna subarray of the second set of antenna subarrays and a centroid of a second shape may be offset from the vertical direction by a respective angular offset different than the first angular offset. In some examples, the first set of antenna subarrays may be configured to transmit signaling to or receive signaling from the second set of antenna subarrays.

In some examples of the system described herein, within a set of angular offsets that includes the respective angular offset for each antenna subarray of the second set of antenna subarrays, each other angular offset may differ from the first angular offset by at least as much as a second angular offset, and a difference between the first angular offset and the second angular offset may be based on a first quantity antenna subarrays within the first set of antenna subarrays at the first device, a second quantity of antenna subarrays within the second set of antenna subarrays at the second device, or both.

In some examples of the system described herein, the first device may be configured to receive, from the second device, a message indicating the second angular offset and transmit the signaling to the second set of antenna subarrays based on a difference between the first angular offset and the second angular offset.

In some examples of the system described herein, the first shape and the second shape may be circular shapes or quadrilateral shapes.

In some examples of the system described herein, each antenna subarray of the first set of antenna subarrays may be located at a respective third angular offset relative to a first axis that may be parallel to an edge of a first substrate, and the first set of antenna subarrays may be disposed on the first substrate. In some examples of the system described herein, each antenna subarray of the second set of antenna subarrays may be located at a respective fourth angular offset relative to a second axis that may be parallel to an edge of a second substrate, and the second set of antenna subarrays may be disposed on the second substrate. In some examples, the second axis may be parallel to the first axis, and each respective third angular offset may be different than each respective fourth angular offset.

### BRIEF DESCRIPTION OF THE DRAWINGS

FIG. 1 illustrates an example of a wireless communications system that supports rotated antenna arrays for wireless communications in accordance with aspects of the present disclosure.

FIG. 2 illustrates an example of a wireless communications system that supports rotated antenna arrays for wireless communications in accordance with aspects of the present disclosure.

FIG. 3 illustrates an example of an orbital angular momentum (OAM) antenna array configuration that supports rotated antenna arrays for wireless communications in accordance with aspects of the present disclosure.

FIG. 4 illustrates an example of an antenna array configuration that supports rotated antenna arrays for wireless communications in accordance with aspects of the present disclosure.

FIG. 5 illustrates an example of an antenna array configuration that supports rotated antenna arrays for wireless communications in accordance with aspects of the present disclosure.

FIG. 6 illustrates an example of a process flow that supports rotated antenna arrays for wireless communications in accordance with aspects of the present disclosure.

FIGS. 7 and 8 show block diagrams of devices that support rotated antenna arrays for wireless communications in accordance with aspects of the present disclosure.

FIG. 9 shows a block diagram of a communications manager that supports rotated antenna arrays for wireless communications in accordance with aspects of the present disclosure.

FIG. 10 shows a diagram of a system including a UE that supports rotated antenna arrays for wireless communications in accordance with aspects of the present disclosure.

FIG. 11 shows a diagram of a system including a base station that supports rotated antenna arrays for wireless communications in accordance with aspects of the present disclosure.

FIGS. 12 and 13 show flowcharts illustrating methods that support rotated antenna arrays for wireless communications in accordance with aspects of the present disclosure.

### DETAILED DESCRIPTION

In some wireless communications systems, wireless devices, such as base stations, user equipments (UEs), network nodes, or any combination thereof, may communicate directionally, for example, using beams to orient communication signals over one or more directions. Various wireless communication schemes, such as line-of-sight multiple-input multiple-output (LoS-MIMO), are being considered for advanced wireless communication systems (e.g., 6G wireless communication systems) to, for example, support high throughput over short distances. In such environments, two network nodes or other devices may communicate using one or more antenna arrays that each include one or more antenna subarrays, antenna elements, or both. An example of LoS-MIMO communication is orbital angular momentum (OAM) multiplexing, in which a transmitting device and a receiving device may each be equipped with a circular antenna array including multiple antenna subarrays disposed along a circumference of the circular array, which may be referred to as a transmitter circle and a receiver circle, respectively. As used herein, a transmitter circle or receiver circle may refer to a circular arrangement of antenna subarrays configured to support OAM multiplexing, and the antenna subarrays of a transmitter circle or receiver circle may but need not be disposed in a perfect circle. Either a transmitter circle or a receiver circle may alternatively be referred to as a circular antenna array, and a transmitter circle may alternatively be referred to as a circular transmitter array while a receiver circle may alternatively be referred to as a circular receiver array. In some LoS-MIMO communication schemes, the transmitting device and the receiving device may each be equipped with antenna subarrays disposed along a perimeter of some other shape, such as a quadrilateral or a spiral.

The transmitting device and the receiving device may transmit and receive one or more waveforms each composed of multiple signals, or samples. Each sample may be generated by a respective antenna subarray at the transmitting device based on a communication mode (e.g., an OAM mode), a weight applied to the respective antenna subarray, or both. The receiving device may receive and sample the waveform at each antenna subarray of the receiving device. Such discrete sampling of the waveform may cause spatial aliasing. Spatial aliasing may refer to interference or inaccuracies in decoding the waveform due to insufficient sampling of the waveform along a space axis. In some cases, the antenna subarrays at the receiving device may be located at the same angular positions along the perimeter of the shape as the antenna subarrays at the transmitting device, which may increase the effects of spatial aliasing at the receiving device.

Techniques described herein provide for antenna subarray configurations that support reduced spatial aliasing. As described herein, an angular offset may be applied between each antenna subarray of the transmitting device and each antenna subarray of the receiving device. The angular offset may provide for the receiving device to receive and decode a more accurate representation of the transmitted signal with fewer aliasing effects than if the transmit and receive antenna subarrays are angularly aligned. The angular offset may also reduce noise and smooth the received signal. For example, the angular offset may position the receive antenna subarray's at one or more locations at which an amplitude of the received waveform may be higher, there may be less interference from higher periodicities of the waveform, or both than if the receive antenna subarrays were aligned with the transmit antenna subarrays.

The angular offset may be defined as a rotational angle between a first reference line (e.g., axis) that extends through a first transmit antenna subarray of the multiple transmit antenna subarrays disposed along a perimeter of a first shape at the transmitting device and a centroid of the first shape and a second reference line (e.g., axis) that extends through a first receive antenna subarray of the multiple receive antenna subarrays disposed along a perimeter of a second shape at the receiving device and a centroid of the second shape. In some examples, the first reference line (e.g., an axis through the first shape) may be offset from a vertical direction by a first angular offset, the second reference line (e.g., an axis through the second shape) may be offset from the vertical direction by a second angular offset, and the applied angular offset may be defined as a difference between the first angular offset and the second angular offset. The angular offset may be applied to antenna subarrays disposed in any combination of shapes, or may be applied to transmit and receive antenna subarrays disposed in a same shape. The shape may be a circle, a quadrilateral, a spiral, or any other shape.

The first angular offset and the second angular offset may be applied at each respective device at installation or during a manufacturing process. Additionally or alternatively, the devices may, in some examples, dynamically activate or deactivate one or more antenna subarrays to apply the respective first or second angular offset. The first and second angular offsets may be configured such that a magnitude of the angular offset between the first and second angular offsets is based on a quantity of antenna subarrays at the transmitting device, a quantity of antenna subarrays at the receiving device, or both, to improve performance. If the quantity of antenna subarrays at either device is an odd number, the effects of aliasing may be reduced and the angular offset may be zero. In some examples, the devices may exchange signaling to indicate a quantity of antenna subarray's at each device, an angular offset of the antenna subarray's, or both, and the devices may determine to communicate based on the signaling. For example, a transmitting device may receive signaling from the receiving device that indicates the second angular offset at the receiving device. The transmitting device may determine to communicate with the receiving device based on a difference between the first angular offset at the transmitting device and the indicated second angular offset. The described angular offset configuration may thereby improve communication reliability for beamformed communications generated using multiple antenna subarrays.

Aspects of the disclosure are initially described in the context of wireless communications systems. Additional aspects are described in the with reference to OAM antenna array configurations, antenna array configurations, and process flows. Aspects of the disclosure are further illustrated by and described with reference to apparatus diagrams, system diagrams, and flowcharts that relate to rotated antenna array's for wireless communications.

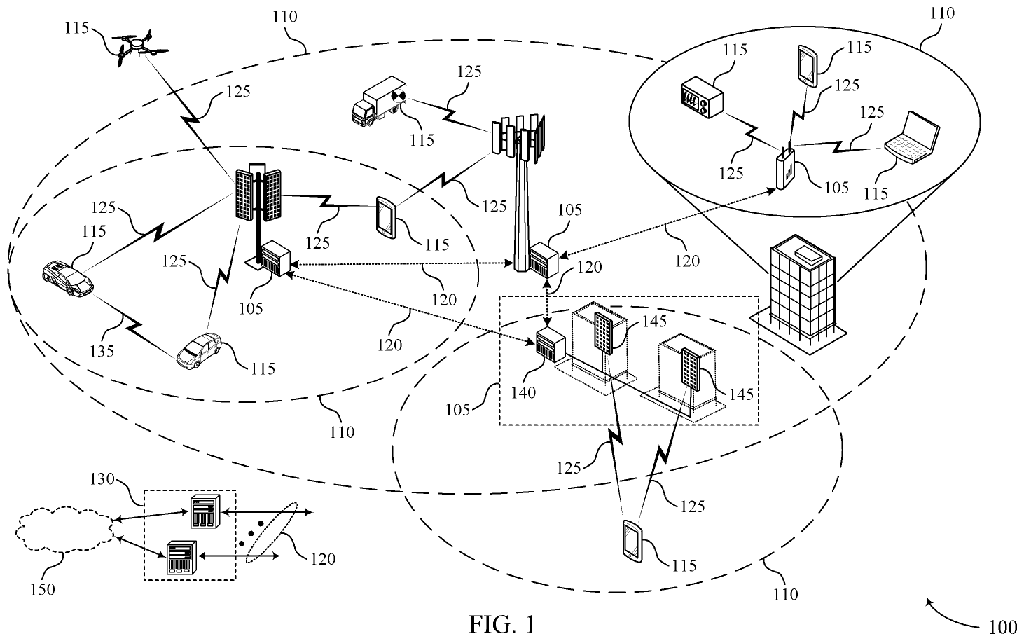

FIG. 1 illustrates an example of a wireless communications system 100 that supports rotated antenna arrays for wireless communications in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Ts=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrow band IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrow band communications), or a combination of these techniques. For example, some UEs 115 may be configured for operation using a narrow band protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some examples, one or more devices in the wireless communications system 100, such as a UE 115, a base station 105, an IAB node, an remote unit (RU), a distributed unit (DU), a centralized unit (CU), or any combination thereof, may include a set of multiple antenna subarray's that each include one or more antenna elements. The devices may perform LoS-MIMO communications, or other beamforming communications using the sets of antenna subarrays. For example, a transmitting device may generate and transmit a waveform using a respective set of antenna subarrays. In some examples, spatial aliasing may occur due to discrete sampling of the waveform at the transmit antenna subarrays.

Techniques described herein may provide for each antenna subarray of a first set of antenna subarrays at a transmitting device to be offset from each antenna subarray of a second set of antenna subarrays at a second device to improve communication reliability and reduce effects of spatial aliasing. The transmitting device may include a first antenna array including the first set of antenna subarrays disposed along a perimeter of a first shape, and the receiving device may include a second antenna array including the second set of antenna subarrays disposed along a perimeter of a second shape. The first and second shapes may be closed shapes (e.g., circles, quadrilaterals, or triangles) or open shapes (e.g., spirals). A first axis that extends between a pair of antenna elements of the first set of antenna subarrays and a centroid of the first shape may be offset from a vertical direction by a first angular offset. A second axis that extends between a pair of antenna elements of the second set of antenna subarrays and a centroid of the second shape may be offset from the vertical axis by a second angular offset that is different than the first angular offset. The second axis may be at least as nearly parallel to the first axis as any other axis that extends between at least two antenna elements of the second set of antenna subarrays and intersects the centroid of the second shape (e.g., have a smallest difference in angular offset relative to the first axis, or at least a difference that is no larger than for any other axis that extends between at least two antenna elements of the second set of antenna subarrays). As used herein, an axis may refer to a line relative to which one or more other dimensions or angles may be defined (e.g., a reference line for such dimensions or angles) and not to a physical component.

The transmitting device may transmit signaling to the receiving device using the first set of antenna subarrays. The receiving device may receive and decode the signaling using the second set of antenna subarrays. In some examples, the receiving device may transmit an indication of the second angular offset to the transmitting device, and the transmitting device may transmit the signaling based on a difference between the first angular offset and the second angular offset to improve communication reliability.

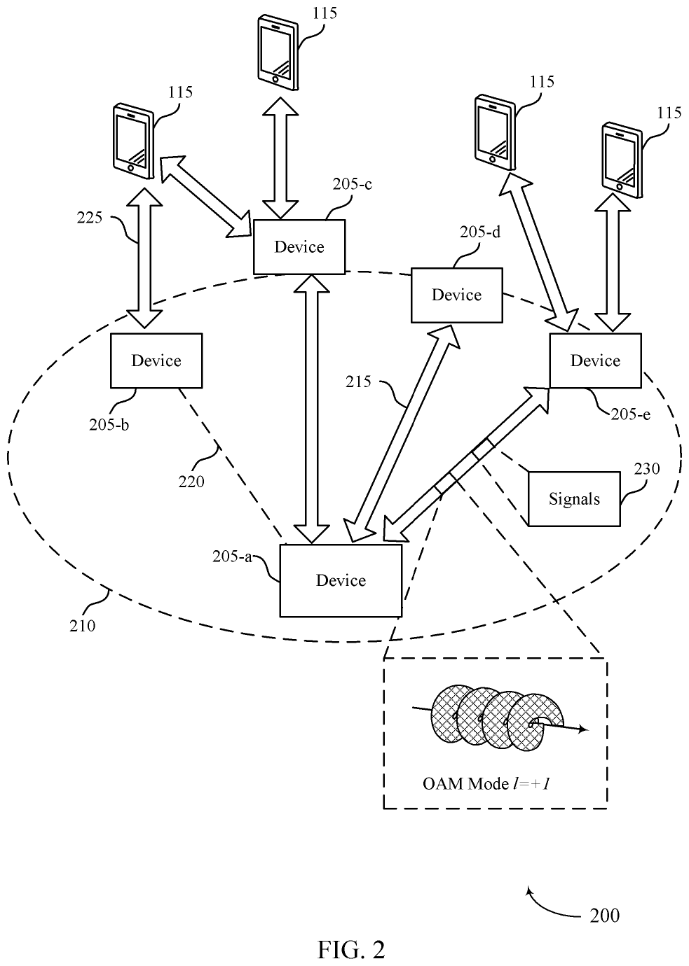

FIG. 2 illustrates an example of a wireless communications system 200 that supports rotated antenna arrays for wireless communications in accordance with aspects of the present disclosure. The wireless communications system 200 may implement or be implemented by aspects of the wireless communications system 100 as described with reference to FIG. 1. The wireless communications system may include one or more devices 205 and UEs 115. The devices 205 may each be an example of a UE 115, a base station 105, an IAB node, a CU, a DU, an RU, or any other wired or wireless device. In some examples, the devices 205-a, 205-b, 205-c, 205-d, and 205-e may form a network device architecture 210, which may be used to relay signals from a radio access network (RAN) (e.g., using smart coordination) to the UEs 115 or other wireless access devices. The wireless communications system 200 (which may be an example of a sixth generation (6G) system, a fifth generation (5G) system, or another generation system) may support LoS-MIMO communications, including OAM-based communications, or other communications. As such, the devices 205, the one or more UEs 115, or both may transmit or receive OAM beams, or LoS-MIMO-related signals over respective communication links.

The device 205-a may represent an example of a core unit of the network device architecture 210, such as a base station 105, a RAN CU, a RAN DU, or some other network node. In some cases, the device 205-a may be connected with the other devices 205 via wired fronthaul/backhaul communication links 220 (e.g., fiber-based fronthaul). Additionally or alternatively, the device 205-a may communicate with one or more other devices 205 of the network device architecture 210 via wireless fronthaul/backhaul communication links 215. The wireless fronthaul/backhaul communication links 215 may reduce cost and deployment complexity as compared with the wired fronthaul/backhaul communication links 220. The other devices 205 may represent examples of distributed network nodes, such as IAB nodes, repeaters, RUs, or any combination thereof that may relay signals from the RAN to one or more UEs 115 or other wireless devices via wireless access communication links 225.

The wireless communications system 200 may support various communications schemes, such as LoS-MIMO. In such environments, a direct link may be present between two or more devices 205 (e.g., without a physical obstruction). For example, the network device architecture 210 may occupy a relatively small area, such that a distance between the devices 205 is relatively short. The devices 205 may communicate according to one or more LoS-MIMO communication schemes using one or more antenna subarrays based on the relatively small distance between devices 205. Such LoS-MIMO communication schemes may support relatively high throughput and data capacities over relatively short distances. As such, LoS-MIMO may provide for the wireless fronthaul/backhaul communication links 215 to support sufficient data capacity between devices 205 of the network device architecture 210 without deploying physical fibers or cables. For example, the device 205-a (e.g., a DU or core network node) may be deployed with an aperture array that connects with one or more other devices 205 (e.g., instead of fibers). In some examples, the performance of the aperture array on the device 205-a may be optimized between the device 205-a and the other devices 205-c. 205-d, and 205-e to support relatively high throughput and capacity of the wireless fronthaul/backhaul communication links 215.

OAM-based communications may be an example of a LOS-MIMO communication scheme supported by the wireless communications system 200. Each of the devices 205, the UEs 115, or both may support OAM communication and may include an OAM antenna system having multiple antenna elements or antenna subarrays arranged in one or more concentric circular arrays. The respective antenna subarrays of the devices 205 may be installed or dynamically adjusted such that they are aligned along a first axis (e.g., a horizontal or vertical axis) as well as rotationally, or such that they are offset by a configured linear or rotational offset. OAM communication may support relatively high-order spatial multiplexing, and in some examples, the offsets between antenna subarrays may be configured to optimize orthogonality between signals and data throughput. OAM communication may support relatively high data rates between two or more devices 205 over relatively short distances. In some examples, the devices 205 may perform OAM communications in relatively high frequency spectrums (e.g., sub-THz, THz, etc.). Although OAM communication is described in the context of fronthaul and backhaul, it is to be understood that the communication techniques described herein may be applicable to any two wireless devices, include access devices (e.g., UEs 115, CPEs), network devices (e.g., base stations 105, DUs, CUs, RUs, IAB nodes), or both.

The devices 205 may support OAM-based communication by using OAM of electromagnetic waves to distinguish between different signals. For example, a transmitting device 205 may radiate multiple coaxially propagating, spatially-overlapping waves each carrying a data stream through an array of apertures. In some cases, the OAM of the electromagnetic wave may be associated with a field spatial distribution of the electromagnetic wave, which may be in the form of a helical or twisted wavefront shape. For example, an electromagnetic wave may correspond to a helical transverse phase of the form exp(iφl) may carry an OAM mode waveform, where φ may be an azimuthal angle of the waveform and l may be an unbounded integer, which may be referred to as an OAM order, a helical mode, or an OAM mode. Each OAM mode (e.g., OAM modes l= . . . , −2, −1, 0, 1, 2, . . . ) may be orthogonal.

Such OAM modes may be characterized by a wavefront that is shaped as a helix with an optical vortex in the center (e.g., at the beam axis), where each OAM mode is associated with a different helical wavefront structure. The OAM modes may be defined or referred to by the mode index l, where a sign of the mode index l corresponds to a “handedness” (e.g., left or right) of the helix (or helices) and a magnitude of the mode index l (e.g., |l|) corresponds to a quantity of distinct but interleaved helices of the electromagnetic wave.

For example, for an electromagnetic wave associated with an OAM mode index of l=0, the electromagnetic wave may not be helical and the wavefronts of the electromagnetic wave are multiple disconnected surfaces (e.g., the electromagnetic wave is a sequence of parallel planes). For an electromagnetic wave associated with an OAM mode index of l=+1, the electromagnetic wave may propagate in a right-handed pattern (e.g., has a right circular polarization or may be understood as having a clockwise circular polarization) and the wavefront of the electromagnetic wave may be shaped as a single helical surface with a step length equal to a wavelength λ of the electromagnetic wave. An example of such an electromagnetic wave is illustrated in FIG. 2. Similarly, for an OAM mode index of l=−1, the electromagnetic wave may propagate in a left-handed pattern (e.g., has a left circular polarization or may be understood as having a counter-clockwise circular polarization) and the wavefront of the electromagnetic wave may be also be shaped as a single helical surface with a step length equal to the wavelength λ of the electromagnetic wave.

For further example, for an OAM mode index of l=±2, the electromagnetic wave may propagate in either a right-handed pattern (if +2) or in a left-handed pattern (if −2) and the wavefront of the electromagnetic wave may include two distinct but interleaved helical surfaces. In such examples, the step length of each helical surface may be equal to λ/2. Likewise, the phase delay over one revolution of the electromagnetic wave may be equal to ±4π. In general terms, a mode-l electromagnetic wave may propagate in either a right-handed pattern or a left-handed pattern (depending on the sign of l) and may include l distinct but interleaved helical surfaces with a step length of each helical surface equal to λ/|l|. In some examples, an electromagnetic wave may be indefinitely extended to provide for an infinite number of degrees of freedom of the OAM of the electromagnetic wave (e.g., l=0, ±1, ±2, . . . , ±∞). As such, the OAM of the electromagnetic wave may be associated with infinite degrees of freedom.

In some examples, the OAM mode index l of an electromagnetic wave may correspond to or otherwise function as (e.g., be defined as) an additional dimension for signal or channel multiplexing. For example, each OAM mode, which may correspond to an OAM state (of which there may be infinite), may function similarly (e.g., or equivalently) to a communication channel, such as a sub-channel. In other words, an OAM mode or state may correspond to a communication channel, and vice versa. For instance, the devices 205 may communicate separate signals 230 using electromagnetic waves having different OAM modes or states similarly to how the devices may transmit separate signals over different communication channels. In some aspects, such use of the OAM modes or states of an electromagnetic wave to carry different signals 230 may be referred to as the use of OAM beams.

Such OAM waveforms associated with different OAM modes may be orthogonally received at a same time and frequency radio resource, which may improve communication spectrum efficiency with relatively low processing complexity at a receiving device 205. For example, a transmitting device 205, such as the device 205-a, may transmit one or more signals 230 to a receiving device 205, such as the device 205-e, using multiple OAM modes. Each signal 230 may be transmitted according to a respective OAM mode, such that the signals 230 do not overlap or interference with each other. In some examples, two or more signals may be transmitted concurrently. If polarizations are added to the OAM modes, a quantity of orthogonal OAM streams may increase.

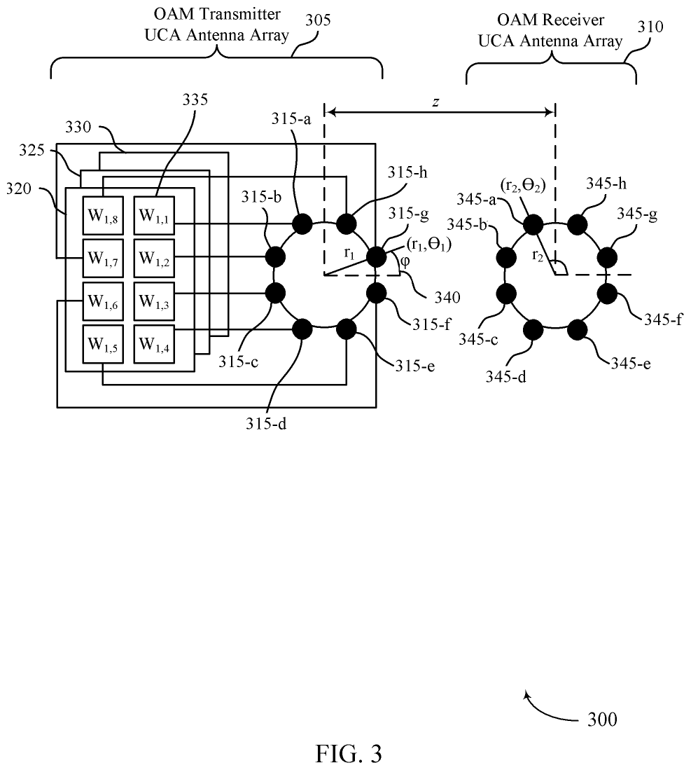

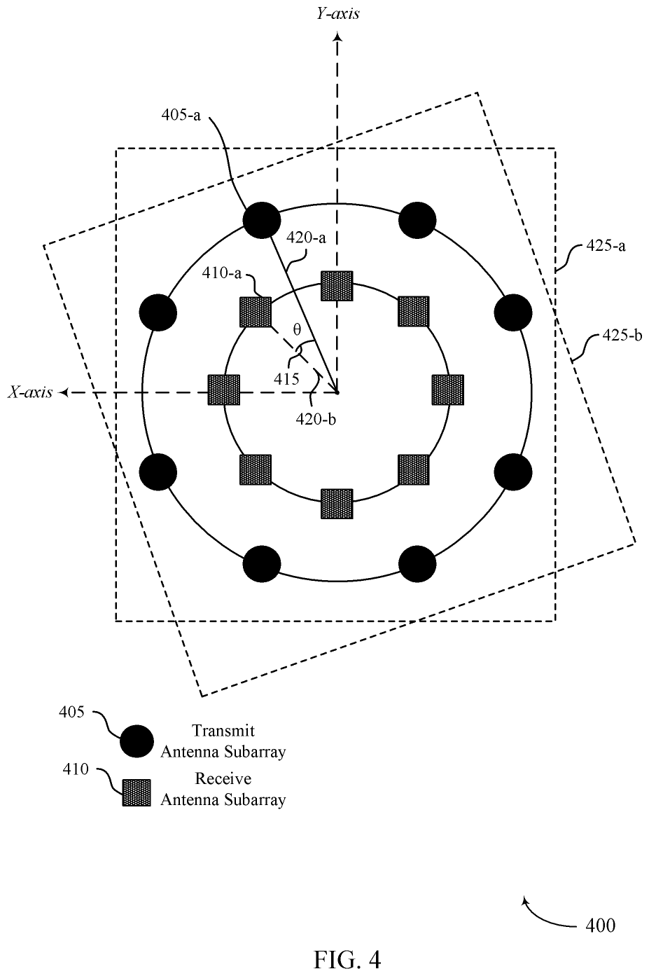

To support such OAM communication, each device 205 may be configured with a set of antenna subarrays configured in a circular shape, such as a uniform circular array (UCA) antenna circle (e.g., an antenna circle, a transmitter circle, or a receiver circle). Each device 205 may be equipped with one or more UCA circles that the device 205 may use to communicate according to one or more OAM modes. The OAM antenna array configurations are described in further detail elsewhere herein, including with reference to FIGS. 3 and 4.

In some examples, the devices 205 may communicate according to other types of LoS-MIMO communications that may be different than OAM beamforming. For example, the devices 205 may communicate using antenna subarrays disposed in a different shape than a circle, such as a rectangular shape or a spiral shape. In such cases, the devices 205 may not support OAM multiplexing using helical waveforms.

Regardless of a shape of the antenna array at a device 205, a device 205 that has multiple antenna subarrays disposed in a geometric shape may support beamforming using the multiple antenna subarrays. For example, the device 205 may apply weights to each antenna subarray and generate a waveform that includes one or more discrete signals, or samples, using each antenna subarray. A receiving device 205 may receive the waveform and sample the waveform at each antenna subarray of multiple antenna subarray's of the receiving device 205.

In some examples, a network provider may deploy multiple devices 205 that each include a same antenna array aperture and configuration to reduce complexity and cost. For example, each device 205 in the wireless communications system 200 may, in some cases, include a same quantity of antenna subarrays disposed in a same geometric shape. The antenna subarrays at each device 205 may additionally or alternatively be angularly aligned. That is, each antenna subarray at the receiving device 205 may be positioned at a same angular offset relative to a first axis that intersects a centroid of the shape of antenna subarrays at the receiving device 205 as each antenna subarray at the transmitting device 205. In some cases, the network provider may deploy the devices 205 with relatively few antenna subarrays to reduce power consumption, complexity, and cost as compared with systems in which each device 205 operates a relatively large quantity of antenna subarray's and corresponding radio frequency (RF) chains. Alternatively, one or more of the devices 205 may be deployed with antenna subarray's disposed in a different shape, a different quantity of antenna subarrays, or both than other devices 205 in the wireless communications system 200.

A transmitting device 205 and receiving device 205 that communicate using multiple antenna subarrays may experience spatial aliasing. Spatial aliasing may correspond to an underrepresentation of a transmitted signal due to insufficient sampling of the signal in space (e.g., due to a discrete quantity of antenna subarrays at each device). The effects of aliasing may decrease as a quantity of transmit antenna subarrays, receive antenna subarrays, or both increases. However, deploying more antenna subarrays may increase cost and complexity of wireless communication.

As described herein, an angular offset may be configured between each antenna subarray of a transmitting device 205 and each antenna subarray of a receiving device 205 to reduce effects of spatial aliasing. A magnitude of the angular offset may be based on a quantity of antenna subarrays at the transmitting device, a quantity of antenna subarrays at the receiving device, or both. The devices 205 may be deployed such that each antenna subarray of a transmitting device 205 is offset from each antenna subarray of a receiving device 205 by the angular offset. Additionally or alternatively, the devices 205 may dynamically activate or deactivate one or more antenna subarray's or adjust an orientation of the antenna subarrays based on the angular offset.

The devices 205 may exchange signaling that indicates the angular offset. For example, a device 205 may transmit signaling to one or more other devices 205 (e.g., via a unicast or broadcast message) that indicates a location of a first antenna subarray of the device 205 relative to a vertical direction, or some other indication of an angular offset applied at the device. The devices 205 may determine whether to communicate based on the indication of the angular offset. For example, if the device 205-a and the device 205-c are each configured with a same angular offset, the devices 205-a and 205-c may determine to refrain from communicating using the respective antenna subarrays based on the angular offsets being the same. In some examples, if the device 205-d indicates a different angular offset, the device 205-a may determine to communicate with the device 205-d.

The signaling may be RRC signaling, a MAC-CE, a physical layer control channel, or any combination thereof configured to indicate the angular offset. The signaling may be transmitted semi-statically (e.g., an RRC configuration). Additionally or alternatively, the devices 205 may dynamically transmit the signaling to indicate changes in angular offsets over time. In some examples, a device 205 may additionally or alternatively indicate a quantity of antenna subarrays at the device 205 via the signaling.

A set of antenna subarrays at a transmitting device 205 may thereby be angularly offset from a set of antenna subarrays at a receiving device 205 to reduce effects of aliasing. The antenna subarrays may be disposed along a perimeter of a shape, such as a circle, spiral, square, or some other shape. Methods for configuring such angular offsets between antenna subarrays are described in further detail elsewhere herein, including with reference to FIGS. 3-5.

FIG. 3 illustrates an example of an OAM antenna array configuration 300 that supports rotated antenna arrays for wireless communications in accordance with aspects of the present disclosure. In some examples, the OAM antenna array configuration 300 may implement aspects of the wireless communications systems 100 or 200 as described with reference to FIGS. 1 and 2. In this example, a transmitting device (e.g., a UE, a base station, an RU, a DU, a CU, an IAB node or some other device) may include an OAM transmitter UCA antenna array 305 and a receiving device (e.g., a UE, a base station, an RU, a DU, a CU, an IAB node or some other device) may include an OAM receiver UCA antenna array 310.

In some aspects, one or both of the OAM transmitter UCA antenna array 305 or the OAM receiver UCA antenna array 310 may be implemented as a planar array of antenna elements, or individual antenna subarrays, which may be an example of or otherwise function as a (massive or holographic) MIMO array or an intelligent surface. In some cases, the transmitting device may identify a set of antenna subarrays 315 of the planar array that form a transmitter UCA (e.g., transmitter antenna subarrays 315-a, 315-b, 315-c, 315-d, 315-e, 315-f, 315-g, and 315-h), and a receiving device may identify a set of antenna subarrays 345 of the planar array that form a receiver UCA (e.g., receiver antenna subarrays 345-a, 345-b, 345-c, 345-d, 345-e, 345-f, 345-g, and 345-h).

Upon selecting the set of antenna subarrays from the planar array, the transmitting device may apply a weight 335 to each of the selected antenna subarrays 315 based on the OAM mode index l of the transmitted OAM beam and one or more spatial parameters associated with each antenna subarray 315. In cases in which a UCA methodology is used to generate an OAM beam, the transmitting device may identify the set of antenna subarrays 315 on a circular array of antenna elements and may apply a first set of weights 320 to each of the identified antenna subarrays 315 based on a first OAM mode index (e.g., l=0). Further, for other OAM mode indices, other weights may be used for the set of antenna subarrays 315, such as a second OAM mode index (e.g., l=+1) that may use a second set of weights 325 and a third OAM mode index (e.g., l=−1) that may use a third set of weights 330. Each OAM mode may be characterized by a different helical wave structure, as described with reference to FIG. 2. The helical wave structure for each mode may be generated by applying the respective set of weights to the antenna subarrays 315 of the transmitting device.

For example, to generate an OAM beam with an OAM mode index (e.g., l=0), the transmitting device may apply a weight 335 to each antenna subarray 315 on the UCA based on an angle 340 measured between a reference line on the UCA (e.g., the x-axis of the plane on which the UCA is located, where the origin is at the center of the UCA) and the antenna subarray 315, the OAM mode index l, and i (e.g., for complex-valued weights, which may alternatively be denoted as j in some cases). In some cases, for instance, the weight for an antenna element n may be proportional to e^{i+l*φ}^{ₙ}, where In is equal to the angle 340 measured between the reference line on the UCA and the antenna element n. By multiplying respective beamforming weights 335 of each set of weights 320-330 (e.g., for first set of weights 320, w₁=[w_{1,1}, w_{1,2}, . . . , w_{1,8}]^{T}) onto each antenna subarray 315, a signal port may be generated. If the weight 335 of each antenna subarray 315 is equal to e^{iφl}, where φ is the angle of an antenna subarray 315 in the circle (e.g., angle 340 for antenna subarray 315-g), and l is the OAM mode index, then each set of weights 320-330 provides a beamformed port that is equivalent to OAM mode l. By using different beamforming weights e^{iφl′}, where l′≠l, multiple OAM modes are thus generated.

At the OAM receiver UCA antenna array 310, the receiving device may have receive antenna subarrays 345 equipped in a circle. The channel matrix may be denoted from each transmit antenna subarray 315 to each receive antenna subarray 345 as H, and then for the beamformed channel matrix \tilde{H}=H·[w₁, w₂, . . . , w_{L}]. Any two OAM weighting vectors of [w₁, w₂, . . . , w_{L}] may be orthogonal relative to each other. In some examples, for N transmit antenna subarrays 315 and N receive antenna subarrays 345, the transfer matrix H may be found via discreet angular sampling using Equation 1, shown below.

$${H}_{m , n} ∝ \frac{exp ( jk \sqrt{{z}^{2} + {( {r}_{1} - {r}_{2} cos {θ}_{2} )}^{2} +} )}{\sqrt{{z}^{2} + {( {r}_{1} cos {θ}_{1} - {r}_{2} cos {θ}_{2} )}^{2} + {( {r}_{1} sin {θ}_{1} - {r}_{2} sin {θ}_{2} )}^{2}}} = \frac{exp \{ jk \sqrt{{z}^{2} + {r}_{1}^{2} + {r}_{2}^{2} - 2 {r}_{1} {r}_{2} cos ( {θ}_{1} - {θ}_{2} )} \}}{\sqrt{{z}^{2} + {r}_{1}^{2} + {r}_{2}^{2} - 2 {r}_{1} {r}_{2} cos ( {θ}_{1} - {θ}_{2} )}} \qquad ( 1 )$$

In the example of Equation 1, beamformed ports may not experience crosstalk because of orthogonality between columns of the transfer matrix H. This may enable OAM-based communication to realize high-level spatial multiplexing more efficiently. Further, the eigen-based transmit precoding weights and receive combining weights of UCA-based OAM procedures may be equal to a discrete Fourier transform (DFT) matrix. As the transfer matrix H is cyclic or circulant, eigenvectors of the transfer matrix H may be DFT vectors, as described in Equation 2.

$${v}_{u} = exp \{ j \frac{2 πμ v}{N} \} \qquad ( 2 )$$

In the example of Equation 2, u and v may be integers within a range (e.g., μ=0, 1, . . . (N−1), v=0, 1, . . . (N−1)), where μ is a vector index of a DFT vector and v is the element index in each DFT vector. With respect to each OAM mode, the μ-th DFT vector may correspond to the μ-th OAM waveform. In some cases, the eigen modes may be identified by performing a singular value decomposition (SVD) on a transfer matrix. In some cases, with N transmit antenna subarrays 315 and receive antenna subarrays 345, all OAM modes (e.g., 0, 1, . . . (N−1) OAM modes) may be orthogonal at the receiver if any of them are transmitted, regardless of distance z and radii of the transmitter and receiver circles.

In some examples, a quantity of transmit antenna subarrays 315 (N) may be different than a quantity of receive antenna subarrays 345 (M). The quantity of antenna subarrays on each device may be based on a condition of a channel between devices, a type of the device (e.g., an RU, a DU, a base station 105, a UE 115, or some other type of device), a size of the device, one or more capabilities of the device, power consumption of the device, or any combination thereof. If the transmitting device is a different type of device or has different capabilities or power restraints than the receiving device, the quantity of transmit antenna subarrays 315 may be different than a quantity of receive antenna subarrays 345 (e.g., M≠N).

In some cases, both transmitter and receiver planes may be co-axial and vertical to the z-axis. Alternatively, in some cases, the transmitter and the receiver antenna subarrays may be mis-aligned in the z-axis (e.g., due to a tilt of one or both of the subarrays relative to the z-axis), or an axis of the transmitter antenna subarray may not be aligned with an axis of the receiver antenna subarray. For example, communications between the antenna subarrays may be transmitted and received at an angle relative to the respective antenna subarrays (e.g., an off-boresight shift). Or, the transmitter and receiver antenna subarrays may be in other configurations.

In some cases, aliasing may occur during communications between the transmitting device and the receiving device using the transmit and receive circles, respectively. Aliasing may correspond to an underrepresentation of a system when the system is represented by finite samples. For example, sampling a continuous signal may create interference or may permit at least some misrepresentation of the continuous signal, which may be referred to as aliasing. In the example of OAM communications, or other LoS-MIMO or beamforming communications that utilize multiple antenna subarrays, the receiver and transmitter circles (e.g., or other shapes of antenna subarrays) may be quantized or digitized to include a finite quantity of antenna subarrays, which may represent the finite samples.

A waveform generated by multiple transmit antenna subarrays 315 may be generated as a function of space, such that the aliasing effect may be referred to as spatial aliasing. The transmitting device may attempt to generate an OAM waveform that is a continuous helical waveform in space. However, an actual OAM waveform generated using a finite quantity of transmit antenna subarrays 315 may be discrete in space, which may cause spatial aliasing. For example, each transmit antenna subarray 315 may generate a signal and a harmonic of the signal may be based on an angle of the respective transmit antenna subarray 315 in the transmitter circle (e.g., the waveform may be a function of space). The receiving device may sample one or more signals received from the transmitting device at each receive antenna subarray 345. In the example of FIG. 3, the signal transmitted by the transmitting device may be sampled eight times (e.g., at each transmit antenna subarray 315), and the signal may be sampled at the receiving device eight times (e.g., at each receive antenna subarray 345).

The receiving device may experience fluctuations or oscillations in the OAM modes used for communications due to interference captured by the finite receive antenna subarrays 345 (e.g., the receive antenna subarrays 345 may capture additional signaling or interference different than the intended OAM mode or may not capture signaling that is part of the intended OAM mode). In some examples, a higher-order OAM mode (e.g., an OAM mode with an index greater than eight) may interfere with a lower-order OAM mode supported by the devices. The receiving device may not be able to distinguish the correct OAM mode from the interfering signals corresponding to other OAM modes. That is, because of the finite samples, the receiver may be unable to differentiate signals generated in accordance with OAM modes corresponding to a faster oscillation from signals generated in according with OAM modes corresponding to a slower oscillation.

The effects of aliasing for a transmitter and receiver circle pair each having a same quantity of antenna subarrays, N, that are not offset by an angular offset may be described with respect to Equations 8 through 10. For example, the mode response of each transmitter and receiver circle pair, as described according to Equation 2, may be further analyzed according to Equation 3, which utilizes Taylor expansion approximations.

$$\sqrt{{z}^{2} + {r}_{1}^{2} + {r}_{2}^{2} - 2 {r}_{1} {r}_{2} cos ( {θ}_{1} - {θ}_{2} )} = z \sqrt{1 + \frac{{r}_{1}^{2} + {r}_{2}^{2} - 2 {r}_{1} {r}_{2} cos ( {θ}_{1} - {θ}_{2} )}{{z}^{2}}} \approx z ( 1 + \frac{{r}_{1}^{2} + {r}_{2}^{2} - 2 {r}_{1} {r}_{2} cos ( {θ}_{1} - {θ}_{2} )}{2 {z}^{2}} ) = z + \frac{{r}_{1}^{2} + {r}_{2}^{2}}{2 z} - \frac{{r}_{1} {r}_{2} cos ( {θ}_{1} - {θ}_{2} )}{z} \qquad ( 3 )$$

Equation 3 may then be incorporated into Equation 1, yielding Equation 4 as shown below.

$${H}_{m , n} ∝ \frac{exp \{ jk \sqrt{{z}^{2} + {r}_{1}^{2} + {r}_{2}^{2} - 2 {r}_{1} {r}_{2} cos ( {θ}_{1} - {θ}_{2} )} \}}{\sqrt{{z}^{2} + {r}_{1}^{2} + {r}_{2}^{2} - 2 {r}_{1} {r}_{2} cos ( {θ}_{1} - {θ}_{2} )}} \approx \frac{exp \{ jk ( z + \frac{{r}_{1}^{2} + {r}_{2}^{2}}{2 z} ) \}}{z} exp \{ \frac{- {jkr}_{1} {r}_{2} cos ( {θ}_{1} - {θ}_{2} )}{z} \} \qquad ( 4 )$$

Assuming a discrete transmitter circle at the transmitting device, with antenna subarrays

$${θ}_{1} = \frac{2 π p}{N}$$

$$and$$

$${θ}_{2} = \frac{2 π n}{N} ,$$

where p=0, 1, . . . (N−1) and n=0, 1, . . . (N−1), if a phase of e^{jlφ}^{₁} is applied by the transmitting device, a total received signal at a receive location of θ₂ on the receiver circle may be represented by Equation 5.

$${\int }_{0}^{2 π} exp \{ - jB cos ( {θ}_{1} - {θ}_{2} ) \} exp ( jl {θ}_{1} ) d {θ}_{1} = {( - j )}^{l} 2 π {J}_{l} ( B ) exp ( jl {θ}_{2} ) \qquad ( 5 )$$

In the example of Equation 5, B may be represented by

$$B = 2 π \frac{{r}_{1} {r}_{2}}{λ z} .$$

However, with discrete sampling by the transmit antenna subarrays 315 (e.g., discrete transmit antenna subarrays 315 located at

$${θ}_{1} = \frac{2 π p}{N} ,$$

with p=0, 1, . . . (N−1)), aliasing may exist. Aliasing may be present when the mode index, l, has a periodicity of N. For example, the received signal at a receive location of θ₂ on the receiver circle when discrete sampling is applied may be represented by Equation 6.

$$\frac{1}{\sqrt{N}} {\sum }_{p = 0}^{N - 1} exp \{ j \frac{2 π pl}{N} \} exp \{ - j 2 π \frac{{r}_{1} {r}_{2}}{λ z} cos ( \frac{2 π p}{N} - {θ}_{2} ) \} ∼ {\sum }_{v = - ∞}^{∞} {J}_{l + vN} ( B ) {( - j )}^{( l + vN )} {e}^{j ( l + vN ) {θ}_{2}} = {\sum }_{v = - ∞}^{∞} {J}_{l + vN} ( B ) {e}^{j ( l + vN ) ( - \frac{π}{2} + {θ}_{2} )} \qquad ( 6 )$$

Aliasing may thereby be present when discrete sampling is performed by the transmitting device, as evidenced by the differences between Equations 5 and 6. Similar aliasing effects may be experienced when a quantity of receive antenna subarrays 345 is different than a quantity of transmit antenna subarrays 315 and there is not an angular offset between transmit antenna subarrays 315 and receive antenna subarrays 345.

In some examples, aliasing may be reduced as a quantity of antenna subarrays at each device increases. However, increasing a quantity of antenna subarrays may increase cost and potential energy consumption by the devices. For example, each antenna subarray may include one or more individual antenna elements, which may each be associated with an RF chain (e.g., RF components or circuitry for the respective transmit or receive antenna element) at the respective device. As a quantity of antenna subarrays increases, complexity and cost of deploying the transmitter and receiver circles may increase. Additionally or alternatively, the devices may consume more power when operating a transmitter or receiver circle that has more antenna subarrays.

In some cases, the transmitter circle at the transmitting device and the receiver circle at the receiver device may be angularly aligned, such that each transmit antenna subarray 315 of the transmitter circle may be angularly aligned with each receive antenna subarray 345 of the receiver circle. For example, there may not be an offset between a first transmit antenna subarray 315-a of the transmitter circle and a first receive antenna subarray 345-a of the receiver circle. That is, the transmit antenna subarray 315-a may be located at a first angular offset relative to the vertical axis and the receive antenna subarray 345-a may be located at the same first angular offset relative to the vertical axis. Each of the remaining transmit antenna subarrays 315-b through 315-h may also be located at a same respective angular offset as each respective receive antenna subarray 345-b through 345-h. Angular alignment between transmit antenna subarrays 315 and receive antenna subarrays 345 may increase the effects of spatial aliasing.

Techniques described herein provide for a configuration of an angular offset between the transmit antenna subarrays 315 and the receive antenna subarrays 345 to reduce or mitigate the effects of spatial aliasing and to improve communication performance and reliability for OAM communications or other LoS-MIMO or beamforming communications. The angular offset may be based on a quantity of transmit antenna subarrays 315, a quantity of receive antenna subarrays 345, or both In some examples, if one or both of the quantity of transmit antenna subarrays 315 and the quantity of receive antenna subarrays 345 is an odd number, the effects of spatial aliasing may be relatively low, and an angular offset may not be applied between the antenna subarray's.

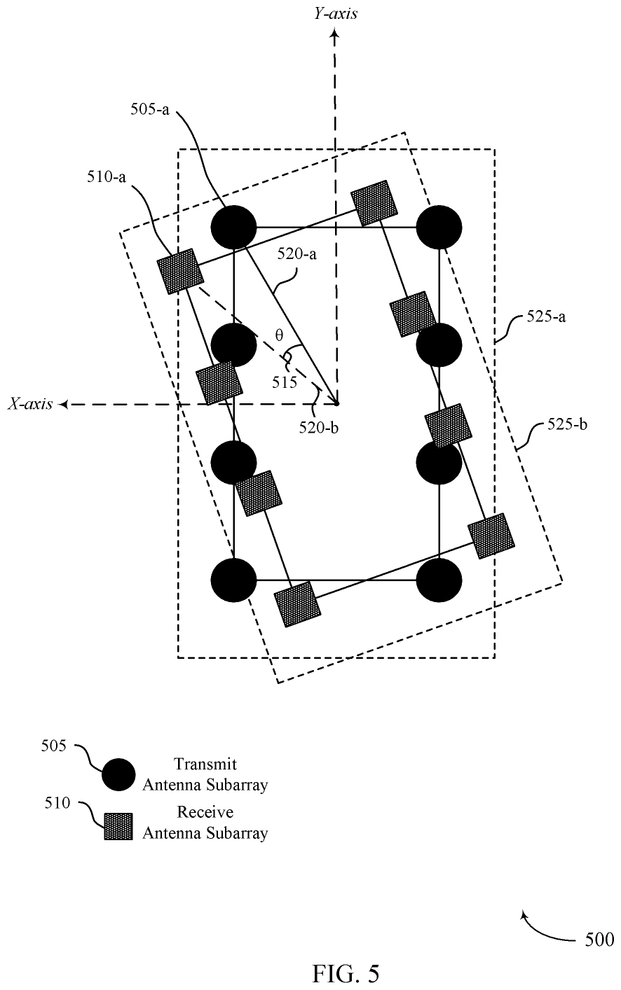

Although FIG. 3 illustrates antenna subarrays disposed in a circle and supportive of OAM communications, it is to be understood that a transmitting device and a receiving device may communicate using respective sets of transmit antenna subarrays 315 and receive antenna subarrays 345 disposed in any shape, such as a rectangle or a spiral. Regardless of a shape of the antenna subarrays, if a transmitting device generates a waveform that includes multiple samples generated at multiple different transmit antenna subarrays 315, spatial aliasing may occur. The described angular offset configuration may be applied to any shape of antenna subarrays and any quantity of antenna subarrays to reduce the effects of spatial aliasing. Such antenna array configurations are described in further detail elsewhere herein, including with reference to FIGS. 4 and 5.

It is to be understood that antenna arrays including multiple antenna subarrays described herein may alternatively be referred to as transmitter circles or receiver circles. Further, the same circular antenna array may at times act as a transmitter circle and may at times act as a receiver circle, but may be referred to as one or the other for the sake of clarity in related descriptions. It is to be understood that any signaling described as received by a device having a transmitter circle could be received via the transmitter circle or via another antenna array, antenna subarray, or antenna element at the device (e.g., a separate receiver circle at the device or some other antenna array or element at the device). Similarly, any signaling described as transmitted by a device having a receiver circle could be transmitted via the receiver circle or via another antenna array, antenna subarray, or antenna element at the device (e.g., a separate transmitter circle at the device or some other antenna array or element at the device). Additionally, though referred to herein as transmit antenna subarrays 315 and receive antenna subarrays 345, it is to be understood that these aspects may alternatively be referred to as transmit antenna arrays and receive antenna arrays, each of which may include multiple antenna elements.

FIG. 4 illustrates an example of an antenna array configuration 400 that supports rotated antenna arrays for wireless communications in accordance with aspects of the present disclosure. The antenna array configuration 400 may implement or be implemented by aspects of the wireless communications system 200 or the OAM antenna array configuration 300. For example, the antenna array configuration 400 illustrates a set of transmit antenna subarrays 405 in a circular configuration (e.g., transmitter circle) at a transmitting device and a set of receive antenna subarrays 410 in a circular configuration (e.g., receiver circle) at a receiving device. Each transmit antenna subarrays 405 in the set of transmit antenna subarrays 405 at the transmitting device and each receive antenna subarrays 410 of the receive antenna subarrays 410 in the set at the receiving device may include one or more antenna elements. The transmitting and receiving devices may represent examples of corresponding devices as described with reference to FIGS. 2 and 3 (e.g., a UE, a base station, a CU, a DU, an RU, an IAB node, or any other device).

As described with reference to FIG. 3, communications between the transmitter circle and the receiver circle may be subject to spatial aliasing. The spatial aliasing may occur based on a finite quantity of transmit antenna subarrays 405 and receive antenna subarrays 410. To reduce the effects of spatial aliasing, a nonzero angular offset 415 as described herein may be applied between the transmit antenna subarrays 405 of the transmitter circle and the receive antenna subarrays 410 of the receiver circle. The angular offset 415 may be a negative or positive rotational angle between a first transmit antenna subarray 405-a of the transmitter circle and a first receive antenna subarray 410-a of the receiver circle. The respective first antenna subarrays 405-a and 410-a may be defined arbitrarily or based on a location of an axis or other reference in the panel, such as an x-axis or y-axis through the circular plane, with an origin at the center of the transmitter and receiver circles.

The angular offset 415 may be illustrated as an angle (e.g., θ) between a first reference line 420-a that extends through the first transmit antenna subarray 405-a (e.g., between two antenna elements of the first transmit antenna subarray 405-a) and intersects a centroid of the transmitter circle and a second reference line 420-b that extends through the first receive antenna subarray 410-a (e.g., between two antenna elements of the first receive antenna subarray 410-a) and intersects a centroid of the receiver circle. The first reference line 420-a may be offset from a vertical direction (e.g., the y-axis) by a first angular offset and the second reference line 420-b may be offset from the vertical direction by a second angular offset. The second reference line 420-b may be at least as nearly parallel to the first reference line 420-a as any other reference line that extends between the centroid of the circles and each other receive antenna subarray 410 (e.g., between at least two antenna elements of the receiver circle). For example, the second reference line 420-b may have a difference in angular offset relative to the first reference line 420-a that is at least as small as (e.g., smaller or at least no larger than) the difference for any other axis or reference line that intersects a receiver antenna subarray 410 of the set of receiver antenna subarrays 410 and the centroid: no other axis or reference line that extends between a receiver antenna subarray 410 of the set of receiver antenna subarrays 410 and intersects the centroid may be any smaller than the difference in angular offset between the second reference line 420-b and the first reference line 420-a. In some examples, the first antenna subarrays 405-a and 410-a may be defined based on the corresponding reference lines 420-a and 420-b, respectively being at least as nearly parallel to each other than other reference lines associated with other antenna subarrays in the circles. The angular offset 415 (e.g., θ) may correspond to a difference between the first and second angular offsets.

The angular offset 415 between the first transmit antenna subarray 405-a and the first receive antenna subarray 410-a may provide for each other transmit antenna subarray 405 to be offset from each other receive antenna subarray 410. That is, the transmitting device may include a set of transmitter antenna subarrays 405 that are each located at a respective first angular offset relative to a first axis that bisects the transmitter circle, and the receiving device may include a set of receiver antenna subarrays 410 that are each located at a respective second angular offset relative to a second axis that bisects the receiver circle and is parallel to the first axis. Each respective first angular offset may be different from each respective second angular offset.

The angular offset 415 may be configured as a positive or negative nonzero value to reduce effects of spatial aliasing as described herein. In some examples, the angular offset 415 may be zero if a quantity of transmitter antenna subarrays 405, a quantity of receiver antenna subarrays 410, or both is an odd number. The angular offset 415 may provide a rotation of the receive antenna subarrays 410 relative to the transmit antenna subarrays 405, such that each receive antenna subarray 410 may be positioned at respective location at which a received signal may be associated with reduced aliasing. For example, if each transmit antenna subarray 405 is aligned with each receive antenna subarray 410, multiple signals having different periodicities may superimpose in one or more locations on the receiver circle, which may cause interference. An amplitude of the received signal may be relatively high at one or more locations of the receiver circle that may be different than a location of a receive antenna subarray 410, in some cases. A periodicity of the amplitude may correspond to an angular periodicity of the receive antenna subarrays 410. As such, by applying the angular offset 415, the receive antenna subarrays 410 may be positioned at or near the location at which the amplitude of the received signal is relatively high, which may provide for the receiving device to receive and decode the signal with improved accuracy. Such positioning may additionally or alternatively reduce effects of interference from signals having higher periodicities.

The value of the angular offset 415 may be based on an analysis of the received signal at the receiving device (e.g., when a quantity, N, of antenna subarrays at each device is even) to improve the accuracy of the communications. The received signal at the n^{th} receive antenna subarray 410 of an subarray of N receive antenna subarrays 410, where the n^{th} receive antenna subarray 410 is at an angle of

$${θ}_{2} = \frac{2 π m}{M} + {θ}_{0} ,$$

may be defined according to Equation 7.

$$Er ( {φ}_{n} ) = {J}_{l} ( B ) {( - j )}^{l} {e}^{jl ( \frac{2 π n}{N} + {θ}_{0} )} + {{\sum }_{v = - ∞ ,}}_{v \neq 0}^{∞} {J}_{l + vN} ( B ) {( - j )}^{( l + vN )} {e}^{j ( l + vN ) ( \frac{2 π n}{2} + {θ}_{0} )} \qquad ( 7 )$$

When the receiving device uses N discrete receive antenna subarrays 410 to perform receiver beamforming, the received signal may be defined according to Equation 8.

$${\sum }_{m = 0}^{M - 1} Er ( {φ}_{m} ) exp [ - jl ( \frac{2 π n}{M} + {θ}_{0} ) ] = {MJ}_{l} ( B ) {( - j )}^{l} + {\sum }_{m = 0}^{M - 1} {\sum }_{{v = - ∞ ,}_{v \neq 0}}^{∞} {J}_{l + vN} ( B ) {( - j )}^{( l + vN )} {e}^{jvN ( \frac{2 π n}{2} + {θ}_{0} )} = {MJ}_{l} ( B ) {( - j )}^{l} + {\sum }_{{v = - ∞ ,}_{v \neq 0}}^{∞} {J}_{l + vN} ( B ) {( - j )}^{( l + vN )} {e}^{j ( l + vN ) {θ}_{0}} \qquad ( 8 )$$

The aliasing term may be defined according to Equation 9.

$$Er ( {φ}_{n} ) = {\sum }_{v = - ∞}^{∞} {J}_{l + vN} ( B ) {e}^{j ( l + vN ) ( - \frac{π}{2} + {θ}_{0} )} {e}^{\frac{2 π ln}{N}} \qquad ( 9 )$$

To reduce the aliasing effect a value of the offset, θ₀, that satisfies Equation 10 may be determined.

$${e}^{jvN {θ}_{0}} = - {e}^{- jvN {θ}_{0}} ⇒ {e}^{j ( 2 vN {θ}_{0} )} = - 1 \qquad ( 10 )$$

To satisfy Equation 10, θ₀ may be determined according to Equation 11.

$${θ}_{0} = \frac{\pm ( 2 n + 1 ) π}{2 vN} \qquad ( 11 )$$

However, Equation 11 may not be true for all values of v (e.g., v=1, 2, 3, . . . ). As such, one choice for θ₀ is

$${θ}_{0} = \pm \frac{π}{2 Nv} .$$

For odd values of v (e.g., v=±1), the aliasing terms N and −N may cancel each outer. If v is relatively large, the angular offset 415 may be zero or a very small value. The angular offset 415 may not be applied to polarization. For example, two polarization modes may be used for each OAM mode. The transmit and receive polarization modes for each OAM mode may be aligned and the transmit antenna subarrays 405 and the receive antenna subarrays 410 may be offset according to the angular offset 415.

An angular offset 415 may thereby be determined (e.g., calculated) to reduce aliasing effects during OAM communications, or other LoS-MIMO beamforming communications. By applying an angular offset 415 as described herein, the effects of aliasing may be reduced and a signal strength of the received signal at each receive antenna subarray 410 may be increased. Additionally or alternatively, the received signal may be smoother and associated with less noise than if the angular offset 415 is not applied.

The angular offset 415 may be based on a quantity of transmit antenna subarrays 405, a quantity of receive antenna subarrays 410, or both, as shown with respect to Equation 11. An example angular offset 415 may be

$$\pm \frac{π}{2 N} ,$$

where N represents the quantity of transmit antenna subarrays 405, the quantity of receive antenna subarrays 410, or both. In some examples, the angular offset may be determined or adjusted based on a distance between the transmitting device and the receiving device, based on a geometry of the respective subarrays, or both (e.g., to optimize the performance for different scenarios). Additionally or alternatively, a common angular offset 415 may be applicable to a range of multiple distances between devices, different angles and alignments of the transmitter and receiver antenna circles, or both. The common angular offset 415 may be chosen to maximize a minimum performance or to maximize a mean performance. In some examples, an angular offset 415 between a certain transmitting and receiving device pair may be chosen randomly from an offset interval range that may be based on the common angular offset 415.

The angular offset 415 may be applied to the transmitter and receiver antenna subarrays when the subarrays are deployed (e.g., based on antenna placement during an antenna panel manufacturing stage of the devices). In some examples, the transmitter circle and the receiver circle may include a same quantity of antenna subarrays and a same or different aperture size. In such cases, a transmit panel may be installed and a receive panel may be arranged with the angular offset 415 relative to the transmit panel (e.g., through physical panel rotation at installation). Additionally or alternatively, the transmitting and receiving devices may dynamically adjust the angular offset 415 during communications (e.g., if a quantity of antenna subarrays on one or both of the transmitter circle or the receiver circle changes).

In some examples, multiple sets of one or more devices may be deployed in a wireless communications system, where a first set of one or more devices may include devices with antenna subarrays that are located at a first offset relative to the y-axis, and a second set of one or more devices may include devices with antenna subarrays that are located at a second offset relative to the y-axis that is different than the first offset. In such cases, an angular offset 415 may not be present between antenna subarrays of devices within a same set, and, as such, the devices within the same set may refrain from communicating. A nonzero angular offset 415 that corresponds to a difference between the first offset and the second offset may be present between devices of different sets. As such, devices of different sets may support communications to reduce aliasing.

The devices may transmit signaling that indicates the respective offsets, as described with reference to FIG. 2. For example, a first device may transmit a broadcast or unicast message to one or more other devices that indicates an offset of the antenna subarrays of the first device, and a second device may determine whether to communicate with the first device based on the indicated offset. The signaling may be RRC signaling, a MAC-CE or a physical layer control channel, or some other type of signaling that is configured to indicate an angular offset 415. In some examples, the devices may adjust the angular offset 415 by moving antenna subarrays or by activating or deactivating one or more antenna subarrays at the device.

In the example of FIG. 4, the transmitter circle and receiver circle in FIG. 4 are illustrated as overlapping and sharing a same centroid for clarity. However, it is to be understood that the transmitter circle may be disposed on a first substrate 425-a at a first device and the receiver circle may be disposed on a second substrate 425-b at a second device that is different than (e.g., many meters distant from) the first device. As such, there may be a distance between the transmitter circle and the receiver circle. The antenna subarrays of each device may be offset relative to one or more edges of the respective substrates 425. For example, each transmit antenna subarray 405 may be located at a respective third angular offset relative to a first axis that is parallel to an edge of the first substrate 425-a, each receive antenna subarray 410 may be located at a respective fourth angular offset relative to a second axis that is parallel to the first axis and an edge of the second substrate 425-b, and each respective third angular offset may be different than each respective fourth angular offset.

Although the transmitter circle is illustrated as being larger than the receiver circle in FIG. 4, it is to be understood that a size of the transmitter circle may be the same as, greater than, or less than a size of the receiver circle. The size of the circles may correspond to an area, a circumference, a diameter, a radius, or any combination thereof of each respective circle. Although eight transmit antenna subarrays 405 and eight receive antenna subarrays 410 are illustrated in FIG. 4, it is to be understood that each circle may include any quantity of antenna subarrays, and, in some examples, a quantity of transmit antenna subarrays 405 in the transmitter circle may be different than a quantity of receive antenna subarrays 410 in the receiver circle.

In some examples, the transmitter antenna circle may or may not be aligned with the receiver circle in each axis. For example, the centroid of the transmitter circle may be at a different location in one or more axes than the centroid of the receiver circle, which may be referred to as an off-boresight shift. In such cases, a line between the centroid of the transmitter circle and the centroid of the receiver circle may be angularly offset from a coaxial line between the devices. Additionally or alternatively, the transmitter circle, the receiver circle, or both may be tilted. That is, a plane of the respective circle may be at an angle relative to a planar axis. The angular offset 415 may be applied regardless of a title or an off-boresight shift between the transmitter and receiver circle to reduce aliasing.

FIG. 5 illustrates an example of an antenna array configuration 500 that supports rotated antenna arrays for wireless communications in accordance with aspects of the present disclosure. The antenna array configuration 500 may implement or be implemented by aspects of the wireless communications system 200 or the antenna array configuration 400. For example, the antenna array configuration 500 illustrates a set of transmit antenna subarrays 505 in a rectangular configuration (e.g., disposed along a perimeter of a rectangular quadrilateral at a transmitting device), which may be referred to as a transmitter rectangle herein, and a set of receive antenna subarrays 510 in a rectangular configuration (e.g., disposed along a perimeter of a rectangular quadrilateral at a receiving device), which may be referred to as a receiver rectangle herein. As described elsewhere herein, transmit antenna subarrays 505 and receive antenna subarrays 510 may be disposed along the perimeter of any type of shape (e.g., their locations intersected by any type of shape, including but not limited to circles and quadrilaterals) in accordance with the teachings herein. Each of the transmit antenna subarrays 505 and the receive antenna subarrays 510 may represent examples of the transmit and receive antenna subarrays described with reference to FIG. 4. For example, each transmit antenna subarray 505 and each receive antenna subarray 510 may include one or more antenna elements. The transmitting and receiving devices may represent examples of corresponding devices as described with reference to FIGS. 2-4 (e.g., a UE, a base station, a CU, a DU, an RU, an IAB node, or any other device).

As described with reference to FIGS. 2-4, communications between the transmitter rectangle and the receiver rectangle may be subject to spatial aliasing. The spatial aliasing may occur based on a quantity of transmit antenna subarrays 505 and receive antenna subarrays 510 being finite. To reduce the effects of spatial aliasing, a nonzero angular offset 515 as described herein may be applied between the transmit antenna subarrays 505 of the transmitter rectangle and the receive antenna subarrays 510 of the receiver rectangle. The angular offset 515 may be a negative or positive rotational angle between a first transmit antenna subarray 505-a of the transmitter rectangle and a first receive antenna subarray 510-a of the receiver rectangle. The respective first antenna subarrays 505-a and 510-a may be defined arbitrarily or based on a location of an axis or other reference in the panel, such as an x-axis or y-axis through the rectangular plane, with an origin at the center of the transmitter and receiver rectangles.

The angular offset 515 may be illustrated as an angle between a first reference line 520-a that extends through the first transmit antenna subarray 505-a (e.g., between two antenna elements of the first transmit antenna subarray 505-a) and intersects a centroid of the transmitter rectangle and a second reference line 520-b that extends through the first receive antenna subarray 510-a (e.g., between two antenna elements of the first receive antenna subarray 510-a) and intersects a centroid of the receiver rectangle. The second reference line 520-b may be at least as nearly parallel to the first reference line 520-a as any other reference line that extends between the centroid of the rectangles and each other receive antenna subarray 510 (e.g., between at least two antenna elements of the receiver rectangle). The first reference line 520-a may be offset from a vertical direction (e.g., the y-axis) by a first angular offset and the second reference line 520-b may be offset from the vertical direction by a second angular offset. The angular offset 515 (e.g., θ) may correspond to a difference between the first and second angular offsets.

The angular offset 515 between the first transmit antenna subarray 505-a and the first receive antenna subarray 510-a may provide for each other transmit antenna subarray 505 to be offset from each other receive antenna subarray 510. That is, the transmitting device may include a set of transmitter antenna subarrays 505 that are each located at a respective third angular offset relative to a first axis that bisects the transmitter rectangle, and the receiving device may include a set of receive antenna subarrays 510 that are each located at a respective fourth angular offset relative to a second axis that bisects the receiver rectangle and is parallel to the first axis. Each respective third angular offset may be different from each respective fourth angular offset.

In some examples, the angular offset 515 may be applied by rotating the receiver rectangle relative to the transmitter rectangle, or vice versa. For example, in FIG. 5, a third axis that is parallel to two sides of the transmitter rectangle and that intersects the centroid of the transmitter rectangle may be parallel to the vertical direction (e.g., the y-axis). In some examples (not pictured in FIG. 5), the third axis may be offset from the vertical direction by a third angular offset. A fourth axis that is parallel to two sides of the receiver rectangle and that intersects the centroid of the receiver rectangle may be offset from the vertical direction by a fourth angular offset that is different than the third angular offset (e.g., a rotation of the third axis). In such cases, a difference between the third and fourth angular offsets may correspond to the angular offset 515.

The angular offset 515 may be configured as a positive or negative nonzero value to reduce effects of spatial aliasing as described herein, including with reference to FIGS. 2-4. In some examples, the angular offset 515 may be zero if a quantity of transmitter antenna subarrays 505, a quantity of receiver antenna subarrays 510, or both is an odd number, as described with reference to FIG. 4. In some cases, if the transmit antenna subarrays 505 are aligned with the receive antenna subarrays 510, an amplitude of the received signal may be relatively high at one or more locations of the receiver rectangle that may be different than a location of a receive antenna subarray 510. As such, by applying the angular offset 515, the receive antenna subarrays 510 may be positioned at or near the location at which the amplitude of the received signal is relatively high, which may provide for the receiving device to receive and decode the signal with improved accuracy. Such positioning may additionally or alternatively reduce effects of interference from signals having higher periodicities.

The value of the angular offset 515 may be based on an analysis of the received signal at the receiving device (e.g., when a quantity, N, of antenna subarrays at each device is even) to improve the accuracy of the communications. The value of the angular offset 515 may be the same as or similar to the value of the angular offset 415 described with respect to FIG. 4 and Equations 7-11. For example, the angular offset 515 may be

$$\pm \frac{π}{2 N} ,$$

where N represents the quantity of transmit antenna subarrays 505, the quantity of receive antenna subarrays 510, or both.

The angular offset 515 may be applied to the transmitter and receiver antenna subarrays when the subarrays are deployed (e.g., during panel manufacturing or installation), or the transmitting and receiving devices may dynamically adjust the angular offset 515 during communications, as described with reference to FIG. 4. The devices may exchange signaling to indicate an angular offset, a quantity of antenna subarrays, or both at each device, and the devices may determine whether to communicate with each other based on the signaling, as described with reference to FIGS. 2-4.

The transmitter rectangle and receiver rectangle in FIG. 5 are illustrated as overlapping and sharing a same centroid for clarity. However, it is to be understood that the transmitter rectangle may be disposed on a first substrate 525-a at a first device and the receiver rectangle may be disposed on a second substrate 525-b at a second device that is different than (e.g., many meters distant from) the first device. As such, there may be a distance between the transmitter rectangle and the receiver rectangle. The antenna subarray's of each device may be offset relative to one or more edges of the respective substrates 525. For example, each transmit antenna subarray 505 may be located at a respective third angular offset relative to a first axis that is parallel to an edge of the first substrate 525-a, each receive antenna subarray 510 may be located at a respective fourth angular offset relative to a second axis that is parallel to the first axis and an edge of the second substrate 525-b, and each respective third angular offset may be different than each respective fourth angular offset

A size of the transmitter rectangle may be the same as, greater than, or less than a size of the receiver rectangle. The size of the rectangle may correspond to an area, a perimeter, a length of each side, or any combination thereof of each respective rectangle. In some examples, one or both of the rectangles may be a square or some other type of quadrilateral.

Additionally or alternatively, the antenna subarrays at one or both devices may be disposed along a perimeter of some other shape, such as a spiral. Although eight transmit antenna subarrays 505 and eight receive antenna subarrays 510 are illustrated in FIG. 5, it is to be understood that each rectangle may include any quantity of antenna subarrays, and, in some examples, a quantity of transmit antenna subarrays 505 in the transmitter rectangle may be different than a quantity of receive antenna subarrays 510 in the receiver rectangle.

In some examples, the transmitter rectangle may or may not be aligned with the receiver rectangle in each axis. For example, the centroid of the transmitter rectangle may be at a different location in one or more axes than the centroid of the receiver rectangle, which may be referred to as an off-boresight shift. In such cases, a line between the centroid of the transmitter rectangle and the centroid of the receiver rectangle may be angularly offset from a coaxial line between the devices. Additionally or alternatively, the transmitter rectangle, the receiver rectangle, or both may be tilted. That is, a plane of the respective rectangle may be at an angle relative to a planar axis. The angular offset 515 may be applied regardless of a title or an off-boresight shift between the transmitter and receiver rectangles to reduce aliasing.

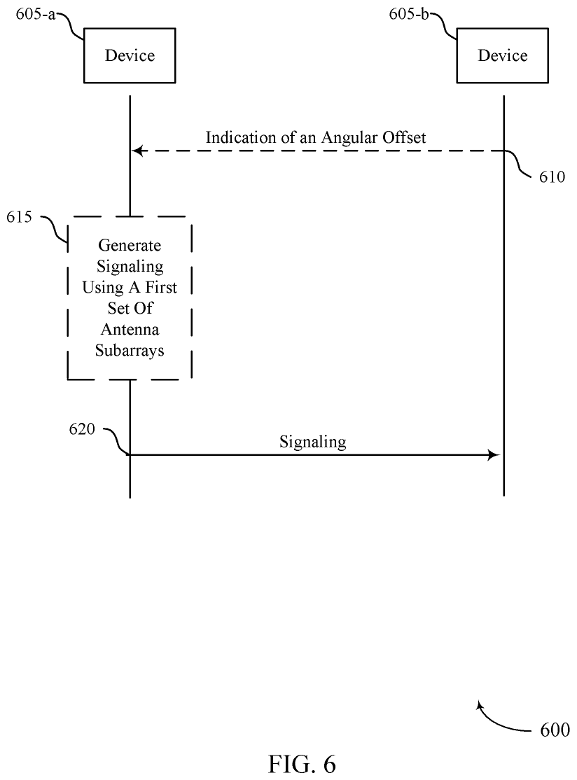

FIG. 6 illustrates an example of a process flow 600 that supports rotated antenna arrays for wireless communications in accordance with aspects of the present disclosure. The process flow 600 may implement or be implemented by aspects of the wireless communications systems 100 and 200. For example, the process flow 600 illustrates OAM communications between a device 605-a and a device 605-b, which may represent examples of corresponding devices as described with reference to FIGS. 2-5. The devices 605 may be UEs, base stations, IAB nodes, RUs, CUs, DUs, or any combination thereof, that support OAM communications. The device 605-a may include a first antenna array including a first set of antenna subarrays disposed along a perimeter of a first shape and the device 605-b may include a second antenna array including a second set of antenna subarrays disposed along a perimeter of a second shape. Each antenna subarray of the first and second sets of antenna subarrays may include one or more antenna elements.

In the following description of the process flow 600, the operations between the device 605-a and the device 605-b may be performed in different orders or at different times. Some operations may also be left out of the process flow 600, or other operations may be added. Although the device 605-a and the device 605-b are shown performing the operations of the process flow 600, some aspects of some operations may also be performed by one or more other wireless devices.

At 610, in some examples, the device 605-b (e.g., a receiving device 605) may transmit an indication of a second angular offset at the device 605-b to the device 605-a (e.g., a transmitting device 605). The second angular offset may correspond to a rotational angle or offset between a vertical direction and a second axis of the second shape at the device 605-b. For example, the second axis may extend between two antenna elements of the second set of antenna subarrays and may intersect a centroid of the second shape. The second axis may be offset from the vertical direction by the second angular offset.

At 615, in some examples, the device 605-a may generate signaling using the first set of antenna subarrays at the device 605-a. At 620, the device 605-a may transmit the signaling from the first set of antenna subarrays at the device 605-a to the second set of antenna subarrays at the device 605-b. In some examples, a first axis that intersects an antenna subarray of the first set of antenna subarrays and a centroid of the first shape may be offset from the vertical direction by a first angular offset that is different than the second angular offset. The second axis may be at least as nearly parallel to the first axis as any other axis that extends between at least two antenna elements of the second set of antenna subarrays and intersects the centroid of the second shape. In such cases, the device 605-a may generate and transmit the signaling to the device 605-b based on a difference between the first angular offset and the second angular offset as indicated at 610.

In some examples, the difference between the first angular offset and the second angular offset may be based on a first quantity of antenna subarrays within the first set of antenna subarrays at the device 605-a, a second quantity of antenna subarrays within the second set of antenna subarrays at the device 605-b, or both. The difference between the first angular offset and the second angular offset may be an example of an angular offset 415 or 515 as described with reference to FIGS. 4 and 5. The first shape and the second shape may each be a circle, a polygon, or a quadrilateral having first and second sizes that may be the same or different. A size of each shape may include a respective area, a respective perimeter distance, a respective circumference, a respective diameter, or any combination thereof.

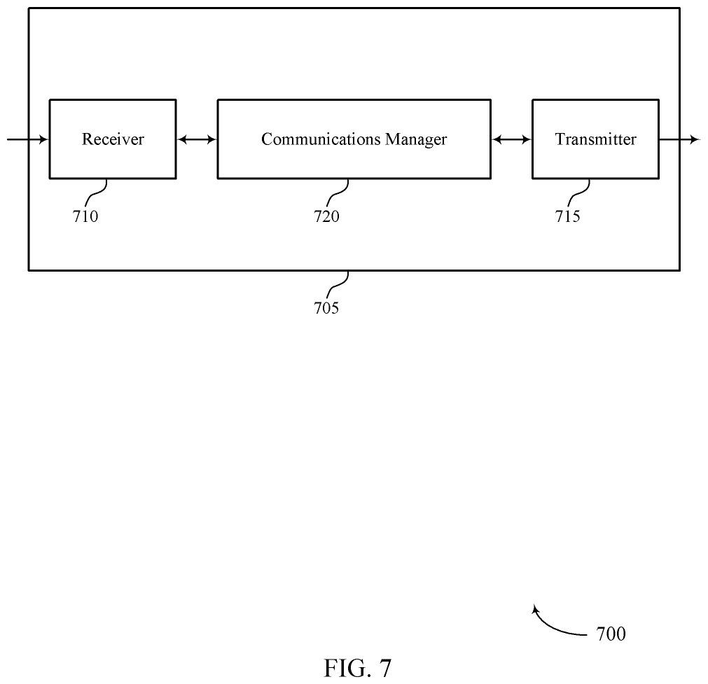

FIG. 7 shows a block diagram 700 of a device 705 that supports rotated antenna arrays for wireless communications in accordance with aspects of the present disclosure. The device 705 may be an example of aspects of a UE 115 or a base station 105 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to rotated antenna arrays for wireless communications). Information may be passed on to other components of the device 705. The receiver 710 may utilize a single antenna or a set of multiple antennas. For example, the receiver 710 may include or be coupled with a set of antenna arrays disposed along a perimeter of a shape, as described herein.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to rotated antenna arrays for wireless communications). In some examples, the transmitter 715 may be co-located with a receiver 710 in a transceiver module. The transmitter 715 may utilize a single antenna or a set of multiple antennas. For example, the transmitter 715 may include or be coupled with a set of antenna arrays disposed along a perimeter of a shape, as described herein.

The communications manager 720, the receiver 710, the transmitter 715, or various combinations thereof or various components thereof may be examples of means for performing various aspects of wireless communications using rotated antenna arrays as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 720 may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communication at a first device in accordance with examples as disclosed herein. For example, the communications manager 720 may be configured as or otherwise support a means for transmitting signaling from a first antenna array including a first set of antenna subarrays at the first device to a second antenna array including a second set of antenna subarrays at a second device. Each antenna subarray of the first set of antenna subarrays and each antenna subarray of the second set of antenna subarrays may include one or more antenna elements. A first axis that intersects an antenna subarray of the first set of antenna subarrays and a centroid of a first shape may be offset from a vertical direction by a first angular offset, and each antenna subarray of the first set of antenna subarrays may be disposed along a perimeter of the first shape. In some examples, for each antenna subarray of the second set of antenna subarrays, a respective angular offset between a respective axis that intersects the antenna subarray of the second set of antenna subarrays and a centroid of a second shape may be offset from the vertical direction by a respective angular offset different than the first angular offset, and each antenna subarray of the second set of antenna subarrays may be disposed along a perimeter of the second shape.

Additionally or alternatively, the communications manager 720 may support wireless communication at a second device in accordance with examples as disclosed herein. For example, the communications manager 720 may be configured as or otherwise support a means for receiving signaling from a first antenna array including a first set of antenna subarrays at a first device using a second antenna array including a second set of antenna subarray's at the second device. Each antenna subarray of the first set of antenna subarrays and each antenna subarray of the second set of antenna subarrays may include one or more antenna elements. A first axis that intersects an antenna subarray of the first set of antenna subarrays and a centroid of a first shape may be offset from a vertical direction by a first angular offset, and each antenna subarray of the first set of antenna subarrays may be disposed along a perimeter of the first shape. In some examples, for each antenna subarray of the second set of antenna subarrays, a respective angular offset between a respective axis that intersects the antenna subarray of the second set of antenna subarrays and a centroid of a second shape may be offset from the vertical direction by a respective angular offset different than the first angular offset, and each antenna subarray of the second set of antenna subarrays may be disposed along a perimeter of the second shape.

By including or configuring the communications manager 720 in accordance with examples as described herein, the device 705 (e.g., a processor controlling or otherwise coupled to the receiver 710, the transmitter 715, the communications manager 720, or a combination thereof) may support techniques for reduced complexity, reduced processing, reduced power consumption, and higher throughput. For example, an angular offset may be configured between antenna subarrays at the device 705 (e.g., a transmitting or receiving device) and antenna subarrays at a second device in communication with the device 705, which may provide for improved communication reliability with fewer antenna subarrays at each device than if the angular offset is not applied. By using fewer antenna subarrays, the processor of the device 705 may operate fewer antenna subarrays and corresponding RF chains, which may reduce complexity of the device 705, processing, and power consumption. Additionally or alternatively, the angular offset may reduce effects of spatial aliasing during communications, which may improve throughput and communication reliability.

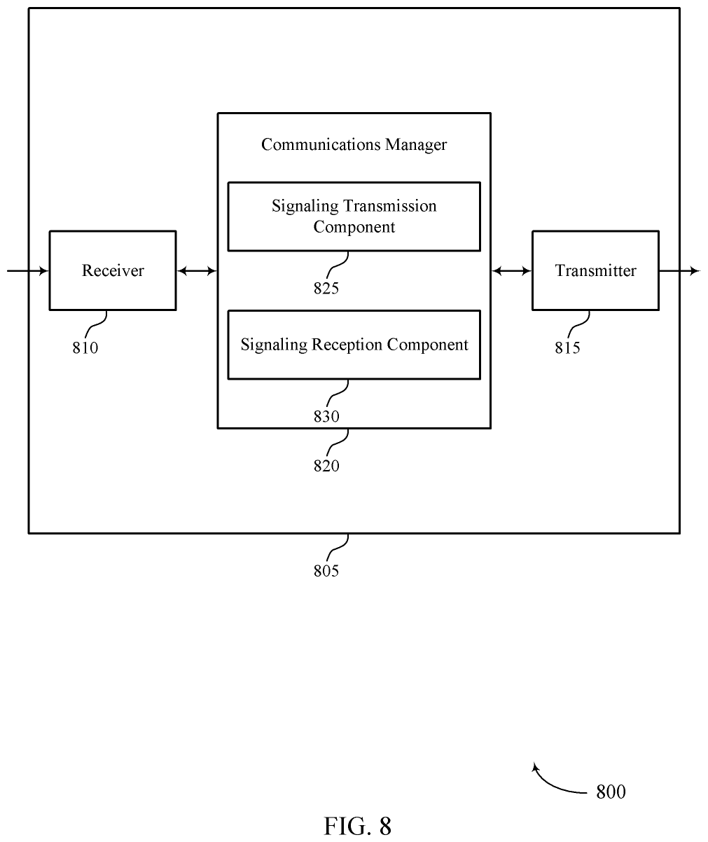

FIG. 8 shows a block diagram 800 of a device 805 that supports rotated antenna arrays for wireless communications in accordance with aspects of the present disclosure. The device 805 may be an example of aspects of a device 705, a UE 115, or a base station 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to rotated antenna arrays for wireless communications). Information may be passed on to other components of the device 805. The receiver 810 may utilize a single antenna or a set of multiple antennas. For example, the receiver 810 may include or be coupled with a set of antenna arrays disposed along a perimeter of a shape, as described herein.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to rotated antenna arrays for wireless communications). In some examples, the transmitter 815 may be co-located with a receiver 810 in a transceiver module. The transmitter 815 may utilize a single antenna or a set of multiple antennas. For example, the transmitter 815 may include or be coupled with a set of antenna arrays disposed along a perimeter of a shape, as described herein.

The device 805, or various components thereof, may be an example of means for performing various aspects of wireless communications using rotated antenna arrays as described herein. For example, the communications manager 820 may include a signaling transmission component 825 a signaling reception component 830, or any combination thereof. The communications manager 820 may be an example of aspects of a communications manager 720 as described herein. In some examples, the communications manager 820, or various components thereof, may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communication at a first device in accordance with examples as disclosed herein. The signaling transmission component 825 may be configured as or otherwise support a means for transmitting signaling from a first antenna array including a first set of antenna subarrays at the first device to a second antenna array including a second set of antenna subarrays at a second device. Each antenna subarray of the first set of antenna subarray's and each antenna subarray of the second set of antenna subarrays may include one or more antenna elements. A first axis that intersects an antenna subarray of the first set of antenna subarrays and a centroid of a first shape may be offset from a vertical direction by a first angular offset, and each antenna subarray of the first set of antenna subarrays may be disposed along a perimeter of the first shape. In some examples, for each antenna subarray of the second set of antenna subarrays, a respective angular offset between a respective axis that intersects the antenna subarray of the second set of antenna subarrays and a centroid of a second shape may be offset from the vertical direction by a respective angular offset different than the first angular offset, and each antenna subarray of the second set of antenna subarrays may be disposed along a perimeter of the second shape.

Additionally or alternatively, the communications manager 820 may support wireless communication at a second device in accordance with examples as disclosed herein. The signaling reception component 830 may be configured as or otherwise support a means for receiving signaling from a first antenna array including a first set of antenna subarrays at a first device using a second antenna array including a second set of antenna subarrays at the second device. Each antenna subarray of the first set of antenna subarrays and each antenna subarray of the second set of antenna subarray's may include one or more antenna elements. A first axis that intersects an antenna subarray of the first set of antenna subarrays and a centroid of a first shape may be offset from a vertical direction by a first angular offset, and each antenna subarray of the first set of antenna subarray's may be disposed along a perimeter of the first shape. In some examples, for each antenna subarray of the second set of antenna subarrays, a respective angular offset between a respective axis that intersects the antenna subarray of the second set of antenna subarrays and a centroid of a second shape may be offset from the vertical direction by a respective angular offset different than the first angular offset, and each antenna subarray of the second set of antenna subarrays may be disposed along a perimeter of the second shape.

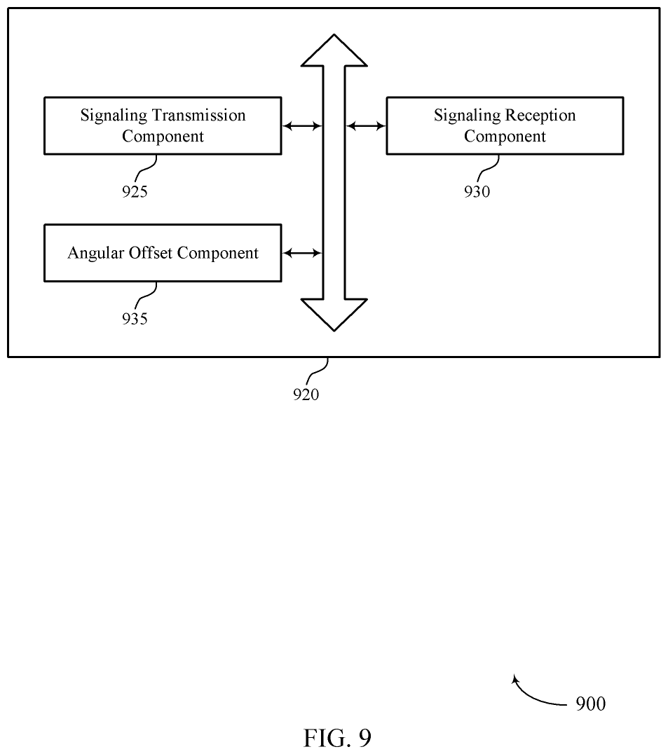

FIG. 9 shows a block diagram 900 of a communications manager 920 that supports rotated antenna arrays for wireless communications in accordance with aspects of the present disclosure. The communications manager 920 may be an example of aspects of a communications manager 720, a communications manager 820, or both, as described herein. The communications manager 920, or various components thereof, may be an example of means for performing various aspects of rotated antenna arrays for wireless communications as described herein. For example, the communications manager 920 may include a signaling transmission component 925, a signaling reception component 930, an angular offset component 935, or any combination thereof. Each of these components may communicate, directly or indirectly, with one another (e.g., via one or more buses).

The communications manager 920 may support wireless communication at a first device in accordance with examples as disclosed herein. The signaling transmission component 925 may be configured as or otherwise support a means for transmitting signaling from a first antenna array including a first set of antenna subarrays at the first device to a second antenna array including a second set of antenna subarrays at a second device. Each antenna subarray of the first set of antenna subarrays and each antenna subarray of the second set of antenna subarrays may include one or more antenna elements. A first axis that intersects an antenna subarray of the first set of antenna subarrays and a centroid of a first shape may be offset from a vertical direction by a first angular offset, and each antenna subarray of the first set of antenna subarrays may be disposed along a perimeter of the first shape. In some examples, for each antenna subarray of the second set of antenna subarrays, a respective angular offset between a respective axis that intersects the antenna subarray of the second set of antenna subarrays and a centroid of a second shape may be offset from the vertical direction by a respective angular offset different than the first angular offset, and each antenna subarray of the second set of antenna subarrays may be disposed along a perimeter of the second shape.

In some examples, within a set of angular offsets that comprises the respective angular offset for each antenna subarray of the second set of antenna subarrays, each other angular offset may differ from the first angular offset by at least as much as a second angular offset, and a difference between the first angular offset and the second angular offset may be based on a first quantity of antenna subarrays within the first set of antenna subarrays at the first device, a second quantity of antenna subarrays within the second set of antenna subarrays at the second device, or both.

In some examples, the angular offset component 935 may be configured as or otherwise support a means for receiving, from the second device, an indication of the second angular offset. In some examples, the signaling transmission component 925 may be configured as or otherwise support a means for transmitting the signaling to the second device based on a difference between the first angular offset and the second angular offset.

In some examples, the first set of antenna subarrays at the first device and the second set of antenna subarrays at the second device may both include a same quantity of antenna subarrays. In some examples, a first of quantity antenna subarrays within the first set of antenna subarrays at the first device may be different than a second quantity of antenna subarrays within the second set of antenna subarrays at the second device.

In some examples, the first shape is a first circle. In some examples, the second shape is a second circle. In some examples, each antenna subarray of the first set of antenna subarrays within the first antenna array may be located at a respective third angular offset relative to a third axis that bisects the first circle. In some examples, each antenna subarray of the second set of antenna subarrays within the second antenna array may be located at a respective fourth angular offset relative to a fourth axis that bisects the second circle, the fourth axis parallel to the third axis. In some examples, each respective third angular offset may be different than each respective fourth angular offset.

In some examples, the first shape is a first quadrilateral. In some examples, the second shape is a second quadrilateral. In some examples, a third axis that is parallel to two sides of the first quadrilateral and that intersects the centroid of the first quadrilateral may be parallel to the vertical direction or may be offset from the vertical direction by a third angular offset. In some examples, a fourth axis that is parallel to two sides of the second quadrilateral and intersects the centroid of the second quadrilateral may be offset from the vertical direction by a fourth angular offset that is different than the third angular offset.

In some examples, regardless of the shape of the first shape or of the second shape, a size of the first shape is the same as a size of the second shape, the size including an area, a perimeter distance, a circumference, a diameter, or any combination thereof of the first shape and the second shape. In some examples, a size of the first shape is different than a size of the second shape, the size of the first shape including a first area, a first perimeter distance, a first circumference, a first diameter, or any combination thereof of the first shape, and the size of the second shape including a second area, a second perimeter distance, a second circumference, a second diameter, or any combination thereof of the second shape.

Additionally or alternatively, the communications manager 920 may support wireless communication at a second device in accordance with examples as disclosed herein. The signaling reception component 930 may be configured as or otherwise support a means for receiving signaling from a first antenna array including a first set of antenna subarrays at a first device using a second antenna array including a second set of antenna subarray's at the second device. Each antenna subarray of the first set of antenna subarrays and each antenna subarray of the second set of antenna subarray's may include one or more antenna elements. A first axis that intersects an antenna subarray of the first set of antenna subarrays and a centroid of a first shape may be offset from a vertical direction by a first angular offset, and each antenna subarray of the first set of antenna subarrays may be disposed along a perimeter of the first shape. In some examples, for each antenna subarray of the second set of antenna subarrays, a respective angular offset between a respective axis that intersects the antenna subarray of the second set of antenna subarrays and a centroid of a second shape may be offset from the vertical direction by a respective angular offset different than the first angular offset, and each antenna subarray of the second set of antenna subarrays may be disposed along a perimeter of the second shape.

In some examples, within a set of angular offsets that comprises the respective angular offset for each antenna subarray of the second set of antenna subarrays, each other angular offset may differ from the first angular offset by at least as much as a second angular offset, and a difference between the first angular offset and the second angular offset may be based on a first quantity of antenna subarrays within the first set of antenna subarrays at the first device, a second quantity of antenna subarrays within the second set of antenna subarrays at the second device, or both.

In some examples, the angular offset component 935 may be configured as or otherwise support a means for transmitting, to the first device, a message indicating the second angular offset. In some examples, the angular offset component 935 may be configured as or otherwise support a means for receiving the signaling from the first device based on a difference between the first angular offset and the second angular offset.

In some examples, a first quantity of antenna subarrays within the first set of antenna subarrays at the first device may be the same as or different than a second quantity of antenna subarrays within the second set of antenna arrays at the second device. In some examples, the first shape and the second shape may be circular shapes or quadrilateral shapes or polygon shapes.

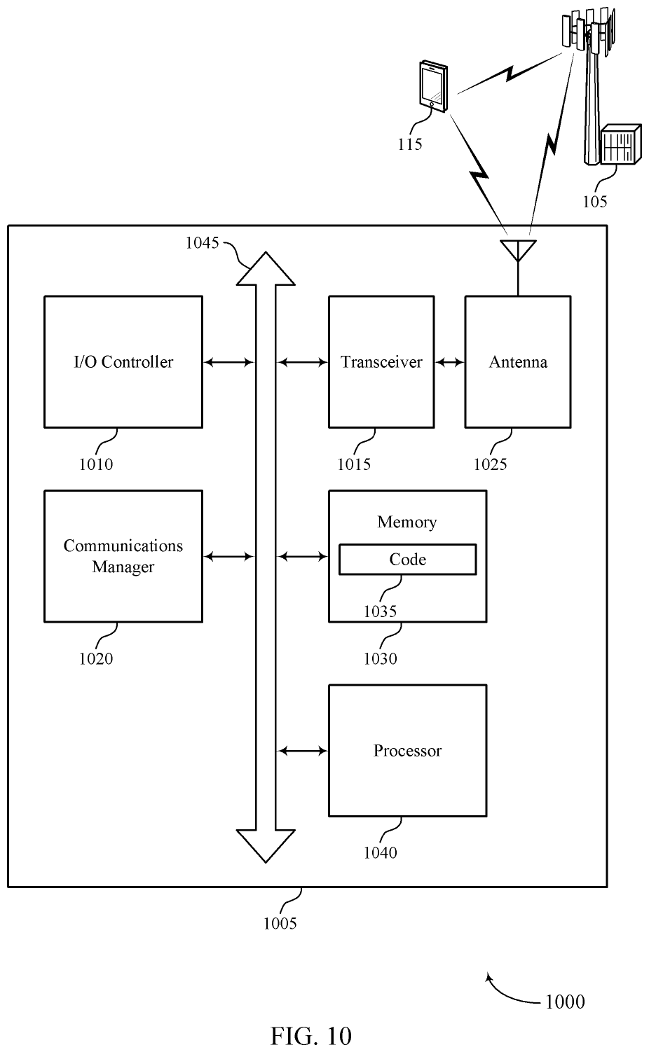

FIG. 10 shows a diagram of a system 1000 including a device 1005 that supports rotated antenna arrays for wireless communications in accordance with aspects of the present disclosure. The device 1005 may be an example of or include the components of a device 705, a device 805, a UE 115, or some other network node (e.g., an IAB node, an RU, a DU, a CU) as described herein. The device 1005 may communicate wirelessly with one or more base stations 105, UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein. For example, the transceiver 1015 may include or be coupled with a set of transmit or receive antenna arrays disposed along a perimeter of a shape, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting wireless communications using rotated antenna arrays). For example, the device 1005 or a component of the device 1005 may include a processor 1040 and memory 1030 coupled to the processor 1040, the processor 1040 and memory 1030 configured to perform various functions described herein.

The communications manager 1020 may support wireless communication at a first device in accordance with examples as disclosed herein. For example, the communications manager 1020 may be configured as or otherwise support a means for transmitting signaling from a first antenna array including a first set of antenna subarrays at the first device to a second antenna array including a second set of antenna subarrays at a second device. Each antenna subarray of the first set of antenna subarrays and each antenna subarray of the second set of antenna subarrays may include one or more antenna elements. A first axis that intersects an antenna subarray of the first set of antenna subarrays and a centroid of a first shape may be offset from a vertical direction by a first angular offset, and each antenna subarray of the first set of antenna subarrays may be disposed along a perimeter of the first shape. In some examples, for each antenna subarray of the second set of antenna subarrays, a respective angular offset between a respective axis that intersects the antenna subarray of the second set of antenna subarrays and a centroid of a second shape may be offset from the vertical direction by a respective angular offset different than the first angular offset, and each antenna subarray of the second set of antenna subarrays may be disposed along a perimeter of the second shape.

Additionally or alternatively, the communications manager 1020 may support wireless communication at a second device in accordance with examples as disclosed herein. For example, the communications manager 1020 may be configured as or otherwise support a means for receiving signaling from a first antenna array including a first set of antenna subarrays at a first device using a second antenna array including a second set of antenna subarrays at the second device. Each antenna subarray of the first set of antenna subarrays and each antenna subarray of the second set of antenna subarrays may include one or more antenna elements. A first axis that intersects an antenna subarray of the first set of antenna subarrays and a centroid of a first shape may be offset from a vertical direction by a first angular offset, and each antenna subarray of the first set of antenna subarrays may be disposed along a perimeter of the first shape. In some examples, for each antenna subarray of the second set of antenna subarrays, a respective angular offset between a respective axis that intersects the antenna subarray of the second set of antenna subarrays and a centroid of a second shape may be offset from the vertical direction by a respective angular offset different than the first angular offset, and each antenna subarray of the second set of antenna subarrays may be disposed along a perimeter of the second shape.

In some examples, the communications manager 1020 may be configured to perform various operations (e.g., receiving, monitoring, transmitting) using or otherwise in cooperation with the transceiver 1015, the one or more antennas 1025, or any combination thereof. For example, the communications manager 1020 may be configured to receive or transmit messages or other signaling as described herein via the transceiver 1015. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of operations for wireless communications as described herein, or the processor 1040 and the memory 1030 may be otherwise configured to perform or support such operations.

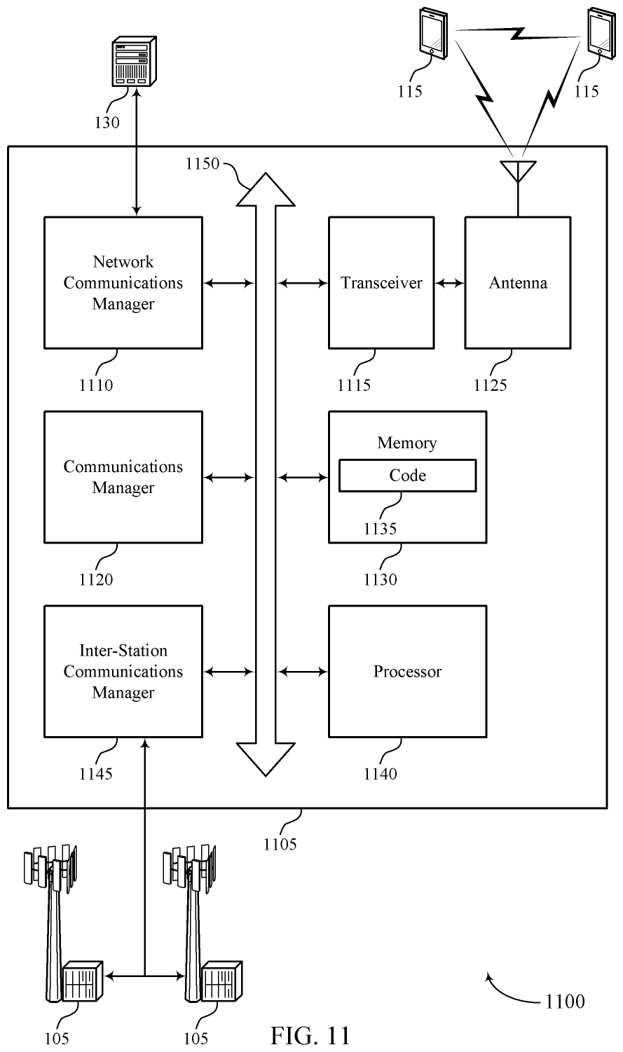

FIG. 11 shows a diagram of a system 1100 including a device 1105 that supports rotated antenna arrays for wireless communications in accordance with aspects of the present disclosure. The device 1105 may be an example of or include the components of a device 705, a device 805, a base station 105, or some other network node (e.g., an IAB node, an RU, a DU, a CU) as described herein. The device 1105 may communicate wirelessly with one or more base stations 105, UEs 115, or any combination thereof. The device 1105 may include components for bi-directional voice and data communications including components for transmitting and receiving communications, such as a communications manager 1120, a network communications manager 1110, a transceiver 1115, an antenna 1125, a memory 1130, code 1135, a processor 1140, and an inter-station communications manager 1145. These components may be in electronic communication or otherwise coupled (e.g., operatively, communicatively, functionally, electronically, electrically) via one or more buses (e.g., a bus 1150).

The network communications manager 1110 may manage communications with a core network 130 (e.g., via one or more wired backhaul links). For example, the network communications manager 1110 may manage the transfer of data communications for client devices, such as one or more UEs 115.

In some cases, the device 1105 may include a single antenna 1125. However, in some other cases the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 715, a transmitter 815, a receiver 710, a receiver 810, or any combination thereof or component thereof, as described herein. For example, the transceiver 1115 may include or be coupled with a set of transmit antenna arrays, receive antenna arrays, or both that are disposed along a perimeter of a shape as described herein.

The memory 1130 may include RAM and ROM. The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a BIOS which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting rotated antenna arrays for wireless communications). For example, the device 1105 or a component of the device 1105 may include a processor 1140 and memory 1130 coupled to the processor 1140, the processor 1140 and memory 1130 configured to perform various functions described herein.

The inter-station communications manager 1145 may manage communications with other base stations 105, and may include a controller or scheduler for controlling communications with UEs 115 in cooperation with other base stations 105. For example, the inter-station communications manager 1145 may coordinate scheduling for transmissions to UEs 115 for various interference mitigation techniques such as beamforming or joint transmission. In some examples, the inter-station communications manager 1145 may provide an X2 interface within an LTE/LTE-A wireless communications network technology to provide communication between base stations 105.

The communications manager 1120 may support wireless communication at a first device in accordance with examples as disclosed herein. For example, the communications manager 1120 may be configured as or otherwise support a means for transmitting signaling from a first antenna array including a first set of antenna subarrays at the first device to a second antenna array including a second set of antenna subarrays at a second device. Each antenna subarray of the first set of antenna subarrays and each antenna subarray of the second set of antenna subarrays may include one or more antenna elements. A first axis that intersects an antenna subarray of the first set of antenna subarrays and a centroid of a first shape may be offset from a vertical direction by a first angular offset, and each antenna subarray of the first set of antenna subarrays may be disposed along a perimeter of the first shape. In some examples, for each antenna subarray of the second set of antenna subarrays, a respective angular offset between a respective axis that intersects the antenna subarray of the second set of antenna subarrays and a centroid of a second shape may be offset from the vertical direction by a respective angular offset different than the first angular offset, and each antenna subarray of the second set of antenna subarrays may be disposed along a perimeter of the second shape.

Additionally or alternatively, the communications manager 1120 may support wireless communication at a second device in accordance with examples as disclosed herein. For example, the communications manager 1120 may be configured as or otherwise support a means for receiving signaling from a first antenna array including a first set of antenna subarrays at a first device using a second antenna array including a second set of antenna subarrays at the second device. Each antenna subarray of the first set of antenna subarrays and each antenna subarray of the second set of antenna subarrays may include one or more antenna elements. A first axis that intersects an antenna subarray of the first set of antenna subarrays and a centroid of a first shape may be offset from a vertical direction by a first angular offset, and each antenna subarray of the first set of antenna subarrays may be disposed along a perimeter of the first shape. In some examples, for each antenna subarray of the second set of antenna subarrays, a respective angular offset between a respective axis that intersects the antenna subarray of the second set of antenna subarrays and a centroid of a second shape may be offset from the vertical direction by a respective angular offset different than the first angular offset, and each antenna subarray of the second set of antenna subarrays may be disposed along a perimeter of the second shape.

By including or configuring the communications manager 1120 in accordance with examples as described herein, the device 1105 may support techniques for improved communication reliability, reduced latency, reduced power consumption, improved coordination between devices, and longer battery life. For example, an angular offset may be applied between each antenna subarray of the device 1105 and each antenna subarray of a second device in communication with the device. The angular offset may reduce effects of spatial aliasing, which may improve throughput and reliability of communications. In some examples, the angular offset may provide for the device 1105 to utilize fewer antenna subarrays for communication than if the angular offset is not applied, which may reduce complexity, processing, and power consumption by the device 1105. The device 1105 may exchange signaling with one or more other devices to indicate an angular offset of each device. Such signaling may provide for improved coordination between devices.

In some examples, the communications manager 1120 may be configured to perform various operations (e.g., receiving, monitoring, transmitting) using or otherwise in cooperation with the transceiver 1115, the one or more antennas 1125, or any combination thereof. For example, the communications manager 1120 may be configured to receive or transmit messages or other signaling as described herein via the transceiver 1115. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of operations for wireless communications as described herein, or the processor 1140 and the memory 1130 may be otherwise configured to perform or support such operations.

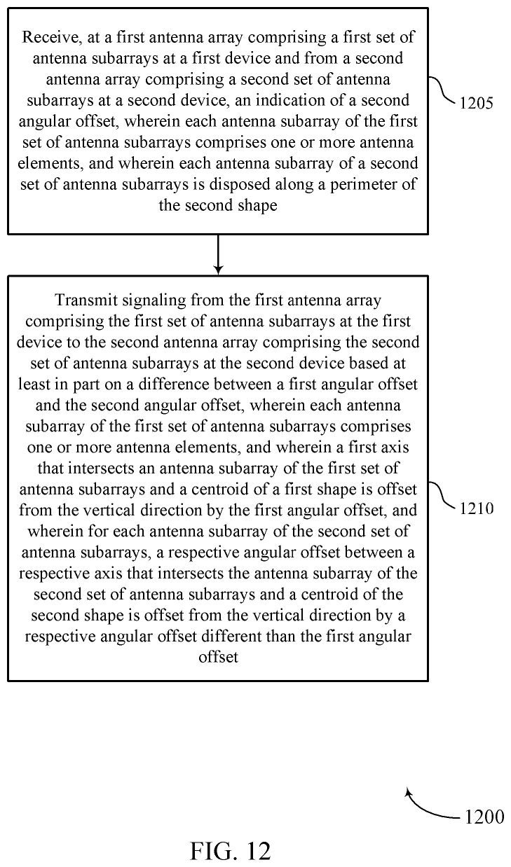

FIG. 12 shows a flowchart illustrating a method 1200 that supports rotated antenna arrays for wireless communications in accordance with aspects of the present disclosure. The operations of the method 1200 may be implemented by a UE, a base station, another device, or its components as described herein. For example, the operations of the method 1200 may be performed by a UE 115 or a base station 105 as described with reference to FIGS. 1 through 11. In some examples, a UE or a base station may execute a set of instructions to control the functional elements of the UE or the base station to perform the described functions. Additionally or alternatively, the UE or the base station may perform aspects of the described functions using special-purpose hardware.

At 1205, the method may include receiving, at a first antenna array including a first set of antenna subarrays at a first device and from a second antenna array including a second set of antenna subarrays at a second device, an indication of a second angular offset. Each antenna subarray of the second set of antenna subarrays may include one or more antenna elements and may be disposed along a perimeter of a second shape. The operations of 1205 may be performed in accordance with examples as disclosed herein. In some examples, aspects of the operations of 1205 may be performed by an angular offset component 935 as described with reference to FIG. 9. Additionally or alternatively, means for performing 1205 may, but not necessarily, include, for example, antenna 1125, transceiver 1115, communications manager 1120, memory 1130 (including code 1135), processor 1140 and/or bus 1150.

At 1210, the method may include transmitting signaling from the first set of antenna subarrays at the first device to the second set of antenna subarrays at the second device based on a difference between a first angular offset and the second angular offset. Each antenna subarray of the first set of antenna subarrays may include one or more antenna elements, and a first axis that intersects an antenna subarray of the first set of antenna subarrays and a centroid of a first shape may offset from a vertical direction by the first angular offset. Each antenna subarray of the first set of antenna subarrays may be disposed around a perimeter of the first shape. For each antenna subarray of the second set of antenna subarrays, a respective angular offset between a respective axis that intersects the antenna subarray of the second set of antenna subarrays and a centroid of the second shape is offset from the vertical direction by a respective angular offset different than the first angular offset. The operations of 1210 may be performed in accordance with examples as disclosed herein. In some examples, aspects of the operations of 1210 may be performed by a signaling transmission component 925 as described with reference to FIG. 9. Additionally or alternatively, means for performing 1205 may, but not necessarily, include, for example, antenna 1125, transceiver 1115, communications manager 1120, memory 1130 (including code 1135), processor 1140 and/or bus 1150.

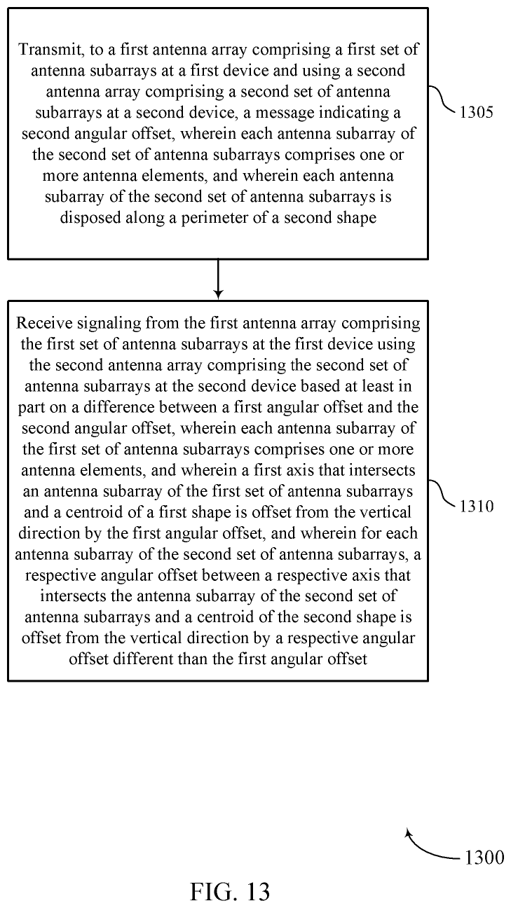

FIG. 13 shows a flowchart illustrating a method 1300 that supports rotated antenna arrays for wireless communications in accordance with aspects of the present disclosure. The operations of the method 1300 may be implemented by a UE, a base station, another second device, or its components as described herein. For example, the operations of the method 1300 may be performed by a UE 115 or a base station 105 as described with reference to FIGS. 1 through 11. In some examples, a UE or a base station may execute a set of instructions to control the functional elements of the UE or the base station to perform the described functions. Additionally or alternatively, the UE or the base station may perform aspects of the described functions using special-purpose hardware.

At 1305, the method may include transmitting, to a first antenna array including a first set of antenna subarrays at a first device and using a second antenna array including a second set of antenna subarrays at a second device, a message indicating a second angular offset. Each antenna subarray of the second set of antenna subarrays may include one or more antenna elements, and may be disposed along a perimeter of a second shape. The operations of 1305 may be performed in accordance with examples as disclosed herein. In some examples, aspects of the operations of 1305 may be performed by an angular offset component 935 as described with reference to FIG. 9. Additionally or alternatively, means for performing 1205 may, but not necessarily, include, for example, antenna 1125, transceiver 1115, communications manager 1120, memory 1130 (including code 1135), processor 1140 and/or bus 1150.

At 1310, the method may include receiving signaling from the first antenna array including the first set of antenna subarrays at the first device using the second antenna array including the second set of antenna subarrays at the second device based on a difference between a first angular offset and the second angular offset. Each antenna subarray of the first set of antenna subarrays may include one or more antenna elements, and a first axis that intersects an antenna subarray of the first set of antenna subarrays and a centroid of a first shape may be offset from the vertical direction by the first angular offset. Each antenna subarray of the first set of antenna subarrays may be disposed along a perimeter of the first shape. In some examples, for each antenna subarray of the second set of antenna subarrays, a respective angular offset between a respective axis that intersects the antenna subarray of the second set of antenna subarrays and a centroid of the second shape is offset from the vertical direction by a respective angular offset different than the first angular offset. The operations of 1310 may be performed in accordance with examples as disclosed herein. In some examples, aspects of the operations of 1310 may be performed by a signaling reception component 930 as described with reference to FIG. 9. Additionally or alternatively, means for performing 1205 may, but not necessarily, include, for example, antenna 1125, transceiver 1115, communications manager 1120, memory 1130 (including code 1135), processor 1140 and/or bus 1150.

The following provides an overview of aspects of the present disclosure:

Aspect 1: A method for wireless communication at a first device, comprising: transmitting signaling from a first antenna array comprising a first set of antenna subarrays at the first device to a second antenna array comprising a second set of antenna subarrays at a second device, wherein: each antenna subarray of the first set of antenna subarrays and each antenna subarray of the second set of antenna subarrays comprises one or more antenna elements: a first axis that intersects an antenna subarray of the first set of antenna subarrays and a centroid of a first shape is offset from a vertical direction by a first angular offset, each antenna subarray of the first set of antenna subarrays disposed along a perimeter of the first shape; and for each antenna subarray of the second set of antenna subarrays, a respective angular offset between a respective axis that intersects the antenna subarray of the second set of antenna subarrays and a centroid of a second shape is offset from the vertical direction by a respective angular offset different than the first angular offset, each antenna subarray of the second set of antenna subarrays disposed along a perimeter of the second shape.

Aspect 2: The method of aspect 1, wherein: within a set of angular offsets that comprises the respective angular offset for each antenna subarray of the second set of antenna subarrays, each other angular offset differs from the first angular offset by at least as much as a second angular offset; and a difference between the first angular offset and the second angular offset is based at least in part on a first quantity of antenna subarrays within the first set of antenna subarrays at the first device, a second quantity of antenna subarrays within the second set of antenna subarrays at the second device, or both.

Aspect 3: The method of aspect 2, further comprising: receiving, from the second device, an indication of the second angular offset, wherein transmitting the signaling to the second device is based at least in part on a difference between the first angular offset and the second angular offset.

Aspect 4: The method of any of aspects 1 through 3, wherein the first set of antenna subarray's at the first device and the second set of antenna subarrays at the second device both comprise a same quantity of antenna subarrays.

Aspect 5: The method of any of aspects 1 through 3, wherein a first quantity antenna subarrays within the first set of antenna subarrays at the first device is different than a second quantity of antenna subarrays within the second set of antenna subarrays at the second device.

Aspect 6: The method of any of aspects 1 through 5, wherein the first shape is a first circle; and the second shape is a second circle.

Aspect 7: The method of aspect 6, wherein each antenna subarray of the first set of antenna subarrays within the first antenna array is located at a respective third angular offset relative to a third axis that bisects the first circle: each antenna subarray of the second set of antenna subarrays within the second antenna array is located at a respective fourth angular offset relative to a fourth axis that bisects the second circle, the fourth axis parallel to the third axis; and each respective third angular offset is different than each respective fourth angular offset.

Aspect 8: The method of any of aspects 1 through 5, wherein the first shape is a first quadrilateral; and the second shape is a second quadrilateral.

Aspect 9: The method of aspect 8, wherein a third axis that is parallel to two sides of the first quadrilateral and that intersects the centroid of the first quadrilateral is offset from the vertical direction by a third angular offset; and a fourth axis that is parallel to two sides of the second quadrilateral and intersects the centroid of the second quadrilateral is offset from the vertical direction by a fourth angular offset that is different than the third angular offset. The third angular offset may be any angular offset, including an angular offset of zero degrees. The fourth angular offset may be any angular offset different than the third angular offset.

Aspect 10: The method of any of aspects 1 through 9, wherein a size of the first shape is the same as a size of the second shape, the size comprising an area, a perimeter, a circumference, a diameter, or any combination thereof of the first shape and the second shape.

Aspect 11: The method of any of aspects 1 through 9, wherein a size of the first shape is different than a size of the second shape, the size of the first shape comprising a first area, a first perimeter, a first circumference, a first diameter, or any combination thereof of the first shape, and the size of the second shape comprising a second area, a second perimeter, a second circumference, a second diameter, or any combination thereof of the second shape.

Aspect 12: A method for wireless communication at a second device, comprising: receiving signaling from a first antenna array comprising a first set of antenna subarrays at a first device using a second antenna array comprising a second set of antenna subarrays at the second device, wherein: each antenna subarray of the first set of antenna subarrays and each antenna subarray of the second set of antenna subarrays comprises one or more antenna elements: a first axis that intersects an antenna subarray of the first set of antenna subarrays and a centroid of a first shape is offset from a vertical direction by a first angular offset, each antenna subarray of the first set of antenna subarrays disposed along a perimeter of the first shape; and for each antenna subarray of the second set of antenna subarrays, a respective angular offset between a respective axis that intersects the antenna subarray of the second set of antenna subarrays and a centroid of a second shape is offset from the vertical direction by a respective angular offset different than the first angular offset, each antenna subarray of the second set of antenna subarrays disposed along a perimeter of the second shape.

Aspect 13: The method of aspect 12, wherein: within a set of angular offsets that comprises the respective angular offset for each antenna subarray of the second set of antenna subarrays, each other angular offset differs from the first angular offset by at least as much as a second angular offset; and a difference between the first angular offset and the second angular offset is based at least in part on a first quantity antenna subarrays within the first set of antenna subarrays at the first device, a second quantity of antenna subarrays within the second set of antenna subarrays at the second device, or both.

Aspect 14: The method of aspect 13, further comprising: transmitting, to the first device, a message indicating the second angular offset, wherein receiving the signaling from the first device is based at least in part on a difference between the first angular offset and the second angular offset.

Aspect 15: The method of any of aspects 12 through 14, wherein a first quantity antenna subarrays within the first set of antenna subarrays at the first device is the same as or different than a second quantity of antenna subarrays within the second set of antenna subarrays at the second device.

Aspect 16: The method of any of aspects 12 through 15, wherein the first shape and the second shape are circular shapes or quadrilateral shapes.

Aspect 17: An apparatus for wireless communication, comprising: a first antenna array comprising a first set of antenna subarrays that each comprise one or more antenna elements, wherein each antenna subarray of the first set of antenna subarrays is disposed along a perimeter of a first shape, and wherein a first axis that intersects an antenna subarray of the first set of antenna subarrays and a centroid of the first shape is offset from a vertical direction by a first angular offset: a processor; and memory coupled with the processor, the memory and the processor configured to cause the apparatus to: transmit signaling to or receive signaling from, using the first set of antenna subarrays, a second antenna array comprising a second set of antenna subarrays at a second device, wherein for each antenna subarray of the second set of antenna subarrays, a respective angular offset between a respective axis that intersects the antenna subarray of the second set of antenna subarrays and a centroid of a second shape is offset from the vertical direction by a respective angular offset different than the first angular offset, and wherein each antenna subarray of the second set of antenna subarrays is disposed along a perimeter of the second shape.

Aspect 18: The apparatus of aspect 17, wherein: within a set of angular offsets that comprises the respective angular offset for each antenna subarray of the second set of antenna subarrays, each other angular offset differs from the first angular offset by at least as much as a second angular offset; and a difference between the first angular offset and the second angular offset is based at least in part on a first quantity of antenna subarrays within the first set of antenna subarrays, a second quantity of antenna subarrays within the second set of antenna subarrays, or both.

Aspect 19: The apparatus of aspect 18, wherein the memory and the processor are further configured to cause the apparatus to: receive, from the second device, an indication of the second angular offset; and transmit the signaling to the second device based at least in part on a difference between the first angular offset and the second angular offset.

Aspect 20: The apparatus of any of aspects 17 through 19, wherein a first quantity of antenna subarrays within the first set of antenna subarrays is the same as a second quantity of antenna subarrays within the second set of antenna subarrays.

Aspect 21: The apparatus of any of claims 17 through 19, wherein a first quantity of antenna subarrays within the first set of antenna subarrays is different than a second quantity of antenna subarrays within the second set of antenna subarrays.

Aspect 22: The apparatus of any of aspects 17 through 21, wherein: the first shape is a first circle; and the second shape is a second circle.

Aspect 23: The apparatus of aspect 22, wherein: each antenna subarray of the first set of antenna subarrays within the first antenna array is located at a respective third angular offset relative to a third axis that bisects the first circle: each antenna subarray of the second set of antenna subarrays within the second antenna array is located at a respective fourth angular offset relative to a fourth axis that bisects the second circle, the fourth axis parallel to the third axis and the vertical direction; and each respective third angular offset is different than each respective fourth angular offset.

Aspect 24: The apparatus of any of aspects 17 through 21, wherein: the first shape is a first quadrilateral; and the second shape is a second quadrilateral.

Aspect 25: The apparatus of aspect 24, wherein: a third axis that is parallel to two sides of the first quadrilateral and that intersects the centroid of the first quadrilateral is offset from the vertical direction by a third angular offset; and a fourth axis that is parallel to two sides of the second quadrilateral and intersects the centroid of the second quadrilateral is offset from the vertical direction by a fourth angular offset that is different than the third angular offset. The third angular offset may be any angular offset, including an angular offset of zero degrees. The fourth angular offset may be any angular offset different than the third angular offset.

Aspect 26: A system for wireless communication, comprising: a first device comprising a first antenna array comprising a first set of antenna subarrays that each comprise one or more antenna elements, wherein each antenna subarray of the first set of antenna subarrays is disposed along a perimeter of a first shape; and a second device comprising a second antenna array comprising a second set of antenna subarrays that each comprise one or more antenna elements, wherein each antenna subarray of the second set of antenna subarrays is disposed along a perimeter of a second shape, wherein: a first axis that intersects an antenna subarray of the first set of antenna subarrays and a centroid of the first shape is offset from a vertical direction by a first angular offset: for each antenna subarray of the second set of antenna subarrays, a respective angular offset between a respective axis that intersects the antenna subarray of the second set of antenna subarrays and a centroid of a second shape is offset from the vertical direction by a respective angular offset different than the first angular offset: and the first set of antenna subarrays is configured to transmit signaling to or receive signaling from the second set of antenna subarrays.

Aspect 27: The system of aspect 26, wherein: within a set of angular offsets that comprises the respective angular offset for each antenna subarray of the second set of antenna subarrays, each other angular offset differs from the first angular offset by at least as much as a second angular offset; and a difference between the first angular offset and the second angular offset is based at least in part on a first quantity antenna subarrays within the first set of antenna subarrays at the first device, a second quantity of antenna subarrays within the second set of antenna subarrays at the second device, or both.

Aspect 28: The system of any of aspects 26 through 27, wherein the first device is configured to receive, from the second device, a message indicating the second angular offset; and transmit the signaling to the second set of antenna subarrays based at least in part on a difference between the first angular offset and the second angular offset.

Aspect 29: The system of any of aspects 26 through 28, wherein the first shape and the second shape are circular shapes or quadrilateral shapes.

Aspect 30: The system of any of aspects 26 through 29, wherein each antenna subarray of the first set of antenna subarrays is located at a respective third angular offset relative to a first axis that is parallel to an edge of a first substrate, the first set of antenna subarrays disposed on the first substrate; each antenna subarray of the second set of antenna subarrays is located at a respective fourth angular offset relative to a second axis that is parallel to an edge of a second substrate, the second set of antenna subarrays disposed on the second substrate and the second axis parallel to the first axis; and each respective third angular offset is different than each respective fourth angular offset.

Aspect 31: An apparatus for wireless communication at a first device, comprising a processor; and memory coupled with the processor, the memory and the processor configured to cause the apparatus to perform a method of any of aspects 1 through 11.

Aspect 32: An apparatus for wireless communication at a first device, comprising at least one means for performing a method of any of aspects 1 through 11.

Aspect 33: A non-transitory computer-readable medium storing code for wireless communication at a first device, the code comprising instructions executable by a processor to perform a method of any of aspects 1 through 11.

Aspect 34: An apparatus for wireless communication at a second device, comprising a processor; and memory coupled with the processor, the memory and the processor configured to cause the apparatus to perform a method of any of aspects 12 through 16.

Aspect 35: An apparatus for wireless communication at a second device, comprising at least one means for performing a method of any of aspects 12 through 16.

Aspect 36: A non-transitory computer-readable medium storing code for wireless communication at a second device, the code comprising instructions executable by a processor to perform a method of any of aspects 12 through 16.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a first device, comprising:
transmitting signaling from a first antenna array comprising a first set of antenna subarrays at the first device to a second antenna array comprising a second set of antenna subarrays at a second device, wherein:
each antenna subarray of the first set of antenna subarrays and each antenna subarray of the second set of antenna subarrays comprises one or more antenna elements;
a first axis that intersects an antenna subarray of the first set of antenna subarrays and a centroid of a first shape is offset from a vertical direction by a first angular offset, each antenna subarray of the first set of antenna subarrays disposed along a perimeter of the first shape; and
for each antenna subarray of the second set of antenna subarrays, a respective angular offset between a respective axis that intersects the antenna subarray of the second set of antenna subarrays and a centroid of a second shape is offset from the vertical direction by a respective angular offset different than the first angular offset, each antenna subarray of the second set of antenna subarrays disposed along a perimeter of the second shape.

2. The method of claim 1, wherein:
within a set of angular offsets that comprises the respective angular offset for each antenna subarray of the second set of antenna subarrays, each other angular offset differs from the first angular offset by at least as much as a second angular offset; and
a difference between the first angular offset and the second angular offset is based at least in part on a first quantity of antenna subarrays within the first set of antenna subarrays at the first device, a second quantity of antenna subarrays within the second set of antenna subarrays at the second device, or both.

3. The method of claim 2, further comprising:
receiving, from the second device, an indication of the second angular offset, wherein transmitting the signaling to the second device is based at least in part on a difference between the first angular offset and the second angular offset.

4. The method of claim 1, wherein the first set of antenna subarrays at the first device and the second set of antenna subarrays at the second device both comprise a same quantity of antenna subarrays.

5. The method of claim 1, wherein a first quantity of antenna subarrays within the first set of antenna subarrays at the first device is different than a second quantity of antenna subarrays within the second set of antenna subarrays at the second device.

6. The method of claim 1, wherein:
the first shape is a first circle; and
the second shape is a second circle.

7. The method of claim 6, wherein:
each antenna subarray of the first set of antenna subarrays within the first antenna array is located at a respective third angular offset relative to a third axis that bisects the first circle;
each antenna subarray of the second set of antenna subarrays within the second antenna array is located at a respective fourth angular offset relative to a fourth axis that bisects the second circle, the fourth axis parallel to the third axis; and
each respective third angular offset is different than each respective fourth angular offset.

8. The method of claim 1, wherein:
the first shape is a first quadrilateral; and
the second shape is a second quadrilateral.

9. The method of claim 8, wherein:
a third axis that is parallel to two sides of the first quadrilateral and that intersects the centroid of the first quadrilateral is offset from the vertical direction by a third angular offset; and
a fourth axis that is parallel to two sides of the second quadrilateral and intersects the centroid of the second quadrilateral is offset from the vertical direction by a fourth angular offset that is different than the third angular offset.

10. The method of claim 1, wherein a size of the first shape is the same as a size of the second shape, the size comprising an area, a perimeter distance, a circumference, a diameter, or any combination thereof of the first shape and the second shape.

11. The method of claim 1, wherein a size of the first shape is different than a size of the second shape, the size of the first shape comprising a first area, a first perimeter distance, a first circumference, a first diameter, or any combination thereof of the first shape, and the size of the second shape comprising a second area, a second perimeter distance, a second circumference, a second diameter, or any combination thereof of the second shape.

12. A method for wireless communication at a second device, comprising:
receiving signaling from a first antenna array comprising a first set of antenna subarrays at a first device using a second antenna array comprising a second set of antenna subarrays at the second device, wherein:
each antenna subarray of the first set of antenna subarrays and each antenna subarray of the second set of antenna subarrays comprises one or more antenna elements;
a first axis that intersects an antenna subarray of the first set of antenna subarrays and a centroid of a first shape is offset from a vertical direction by a first angular offset, each antenna subarray of the first set of antenna subarrays disposed along a perimeter of the first shape; and
for each antenna subarray of the second set of antenna subarrays, a respective angular offset between a respective axis that intersects the antenna subarray of the second set of antenna subarrays and a centroid of a second shape is offset from the vertical direction by a respective angular offset different than the first angular offset, each antenna subarray of the second set of antenna subarrays disposed along a perimeter of the second shape.

13. The method of claim 12, wherein:
within a set of angular offsets that comprises the respective angular offset for each antenna subarray of the second set of antenna subarrays, each other angular offset differs from the first angular offset by at least as much as a second angular offset; and
a difference between the first angular offset and the second angular offset is based at least in part on a first quantity of antenna subarrays within the first set of antenna subarrays at the first device, a second quantity of antenna subarrays within the second set of antenna subarrays at the second device, or both.

14. The method of claim 13, further comprising:
transmitting, to the first device, a message indicating the second angular offset, wherein receiving the signaling from the first device is based at least in part on a difference between the first angular offset and the second angular offset.

15. The method of claim 12, wherein a first quantity of antenna subarrays within the first set of antenna subarrays at the first device is the same as or different than a second quantity of antenna subarrays within the second set of antenna subarrays at the second device.

16. The method of claim 12, wherein the first shape and the second shape are circular shapes or quadrilateral shapes.

17. An apparatus for wireless communication, comprising:
a first antenna array comprising a first set of antenna subarrays that each comprise one or more antenna elements, wherein each antenna subarray of the first set of antenna subarrays is disposed along a perimeter of a first shape, and wherein a first axis that intersects an antenna subarray of the first set of antenna subarrays and a centroid of the first shape is offset from a vertical direction by a first angular offset;
a processor; and
memory coupled with the processor, the memory and the processor configured to cause the apparatus to:
transmit signaling to, or receive signaling from, a second antenna array at a second device using the first antenna array, wherein the second antenna array comprises a second set of antenna subarrays and, for each antenna subarray of the second set of antenna subarrays, a respective angular offset between a respective axis that intersects the antenna subarray of the second set of antenna subarrays and a centroid of a second shape is offset from the vertical direction by a respective angular offset different than the first angular offset, and wherein each antenna subarray of the second set of antenna subarrays is disposed along a perimeter of the second shape.

18. The apparatus of claim 17, wherein:
within a set of angular offsets that comprises the respective angular offset for each antenna subarray of the second set of antenna subarrays, each other angular offset differs from the first angular offset by at least as much as a second angular offset; and
a difference between the first angular offset and the second angular offset is based at least in part on a first quantity of antenna subarrays within the first set of antenna subarrays, a second quantity of antenna subarrays within the second set of antenna subarrays, or both.

19. The apparatus of claim 18, wherein the memory and the processor are further configured to cause the apparatus to:
receive, from the second device, an indication of the second angular offset; and
transmit the signaling to the second device based at least in part on a difference between the first angular offset and the second angular offset.

20. The apparatus of claim 17, wherein a first quantity of antenna subarrays within the first set of antenna subarrays is the same as a second quantity of antenna subarrays within the second set of antenna subarrays.

21. The apparatus of claim 17, wherein a first quantity of antenna subarrays within the first set of antenna subarrays is different than a second quantity of antenna subarrays within the second set of antenna subarrays.

22. The apparatus of claim 17, wherein:
the first shape is a first circle; and
the second shape is a second circle.

23. The apparatus of claim 22, wherein:
each antenna subarray of the first set of antenna subarrays within the first antenna array is located at a respective third angular offset relative to a third axis that bisects the first circle;
each antenna subarray of the second set of antenna subarrays within the second antenna array is located at a respective fourth angular offset relative to a fourth axis that bisects the second circle, the fourth axis parallel to the third axis and the vertical direction; and
each respective third angular offset is different than each respective fourth angular offset.

24. The apparatus of claim 17, wherein:
the first shape is a first quadrilateral; and
the second shape is a second quadrilateral.

25. The apparatus of claim 24, wherein:
a third axis that is parallel to two sides of the first quadrilateral and that intersects the centroid of the first quadrilateral is offset from the vertical direction by a third angular offset; and
a fourth axis that is parallel to two sides of the second quadrilateral and intersects the centroid of the second quadrilateral is offset from the vertical direction by a fourth angular offset that is different than the third angular offset.

26. A system for wireless communication, comprising:
a first device comprising a first antenna array that comprises a first set of antenna subarrays each comprising one or more antenna elements, wherein each antenna subarray of the first set of antenna subarrays is disposed along a perimeter of a first shape; and
a second device comprising a second antenna array that comprises a second set of antenna subarrays each comprising one or more antenna elements, wherein each antenna subarray of the second set of antenna subarrays is disposed along a perimeter of a second shape, wherein:
a first axis that intersects an antenna subarray of the first set of antenna subarrays and a centroid of the first shape is offset from a vertical direction by a first angular offset;
for each antenna subarray of the second set of antenna subarrays, a respective angular offset between a respective axis that intersects the antenna subarray of the second set of antenna subarrays and a centroid of a second shape is offset from the vertical direction by a respective angular offset different than the first angular offset; and
the first set of antenna subarrays is configured to transmit signaling to or receive signaling from the second set of antenna subarrays.

27. The system of claim 26, wherein:
within a set of angular offsets that comprises the respective angular offset for each antenna subarray of the second set of antenna subarrays, each other angular offset differs from the first angular offset by at least as much as a second angular offset; and
a difference between the first angular offset and the second angular offset is based at least in part on a first quantity of antenna subarrays within the first set of antenna subarrays at the first device, a second quantity of antenna subarrays within the second set of antenna subarrays at the second device, or both.

28. The system of claim 27, wherein the first device is configured to:
receive, from the second device, a message indicating the second angular offset; and
transmit the signaling to the second set of antenna subarrays based at least in part on a difference between the first angular offset and the second angular offset.

29. The system of claim 26, wherein the first shape and the second shape are circular shapes or quadrilateral shapes.

30. The system of claim 26, wherein:
each antenna subarray of the first set of antenna subarrays is located at a respective third angular offset relative to a third axis that is parallel to an edge of a first substrate, the first set of antenna subarrays disposed on the first substrate;
each antenna subarray of the second set of antenna subarrays is located at a respective fourth angular offset relative to a fourth axis that is parallel to an edge of a second substrate, the second set of antenna subarrays disposed on the second substrate and the fourth axis parallel to the third axis; and
each respective third angular offset is different than each respective fourth angular offset.
